(19) United States
(12) Patent Application Publication
(10) Pub. No.: US 2026/0288820 A1
(43) Pub. Date: Sep. 24, 2026

(54) AI STUDIO

(71) Applicant: NETRADYNE, INC., San Diego, CA (US)

(72) Inventors: Pramod Akkarachittor, Fremont, CA (US); David Jonathan Julian, Hendersonville, TN (US); Nishanth Chandran, Chennai (IN); Soumyanetra Pal, Bengaluru (IN); Soham Biswas, Bangalore (IN); Nannuri Pranay Kumar Reddy, Bangalore (IN); Pratik Verma, Bengaluru (IN); Anirban Nag, Bengaluru (IN)

(73) Assignee: NETRADYNE, INC., San Diego, CA (US)

(21) Appl. No.: 19/567,981

(22) Filed: Mar. 16, 2026

Related U.S. Application Data
(60) Provisional application No. 63/774,025, filed on Mar. 18, 2025.

(51) Int. Cl. G06F 16/3329; G06F 3/0482

(52) U.S. Cl. CPC G06F 16/33295; G06F 3/0482

(57) ABSTRACT

A method comprises receiving, by a computing device, a natural language description of a desired safety detection skill, indicating a type of safety event and conditions for detection. The method comprises generating a prompt enhancement based on the natural language description, comprising machine-interpretable instructions configured to cause a large language model (LLM) to detect the safety event when conditions are satisfied. The method comprises integrating the prompt enhancement into a pre-deployed LLM prompt executing on at least one edge computing device associated with a vehicle to produce an integrated prompt configured to detect pre-existing safety events and the safety event in a unified execution pass. The method comprises deploying the integrated prompt to the edge computing device for processing sensor data to detect the safety event.

### CROSS-REFERENCE TO RELATED APPLICATIONS

This application claims priority to U.S. Provisional Application No. 63/774,025, filed Mar. 18, 2025, the entire contents of which are hereby incorporated by reference in their entirety.

### FIELD OF THE INVENTION

Certain aspects of the present disclosure generally relate to generative artificial intelligence (AI) models applied to driving safety, and more particularly to systems and methods of improving safety systems using generative AI models by enabling safety managers and other users to directly, such as through an AI studio, create and deploy custom safety and fleet management detection capabilities to vehicles.

### BACKGROUND

The information disclosed in this background section is only for the enhancement of understanding of the general background of the disclosure and should not be taken as an acknowledgement or any form of suggestion that this information forms the prior art already known to a person skilled in the art.

The management of vehicle fleets for safety and compliance has evolved significantly with the introduction of AI-enabled camera systems that can detect various driving events and/or safety violations. These systems typically operate using pre-programmed detection models developed by the system provider, which may be deployed across all customer vehicles. While effective for common safety concerns such as distracted driving, speeding, or following distance violations, these systems face significant limitations when addressing industry-specific or customer-specific safety needs.

Fleet safety managers often encounter unique safety challenges specific to their industry, operational environment, or regulatory requirements. For example, a construction company might need to monitor whether workers at construction sites are wearing required safety helmets when vehicles arrive, while a fuel delivery company might need to detect potential fuel spills during refueling operations. Traditional fleet management systems cannot readily address these specialized needs without significant investment in custom development by the system provider, often involving lengthy requirements gathering, model development, and testing cycles that can take months or years to complete.

Current approaches also require significant technical expertise to develop and deploy new safety detection capabilities. Safety managers, who possess domain knowledge about the safety concerns that need to be addressed, may lack the technical skills to translate this knowledge into functioning detection systems. This creates a dependency on technical teams and slows down the implementation of new safety features.

Accordingly, there is a need for systems and methods that enable safety managers or other safety system users to directly create and deploy custom safety detection capabilities without extensive technical expertise, while efficiently utilizing available bandwidth and computational resources and providing flexible implementation options that align with customer needs and budget constraints.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to an aspect of the present disclosure, a method is provided. The method comprises receiving, by a computing device, a natural language description of a desired safety detection skill. The natural language description indicates a type of a safety event and one or more conditions for detection of the safety event. The method comprises generating, by the computing device, a prompt enhancement based on the natural language description. The prompt enhancement comprises machine-interpretable instructions configured to cause a large language model (LLM) to detect the safety event when the one or more conditions are satisfied. The method comprises integrating, by the computing device, the prompt enhancement into a pre-deployed LLM prompt executing on at least one edge computing device associated with a vehicle to produce an integrated prompt. The integrated prompt is configured to detect one or more pre-existing safety events associated with the pre-deployed LLM prompt and the safety event in a unified execution pass of the LLM. The method comprises deploying, by the computing device, the integrated prompt to the at least one edge computing device for processing sensor data captured by one or more sensors coupled to the at least one edge computing device to detect the safety event.

The integration of the prompt enhancement into the pre-deployed LLM prompt enables detection of a plurality of safety events in a unified execution pass of the LLM, thereby eliminating the need for separate inference passes for each safety detection skill. The unified execution pass avoids multiplicative increases in memory utilization, processing overhead, and power consumption that would result from executing each safety detection skill as an independent detection process on the edge computing device. The prompt enhancement is inserted into a designated custom detection task section of the pre-deployed LLM prompt without modifying a base detection task section defining pre-existing safety detection skills, thereby preserving pre-existing safety detection capabilities in an unmodified state. The systems and methods further address the generation of conditional activation logic that ensures computational resources are consumed only when activation conditions are satisfied, the refinement of prompt enhancements to operate within determined resource constraints of the edge computing device, and the translation of natural language descriptions into machine-executable logic representations serialized in structured portable data formats for hardware-agnostic edge deployment.

According to another aspect of the present disclosure, a system is provided. The system comprises one or more processors and a memory storing instructions. The instructions, when executed by the one or more processors, cause the system to receive a natural language description of a desired safety detection skill. The natural language description indicates a type of a safety event and one or more conditions for detection of the safety event. The instructions cause the system to generate a prompt enhancement based on the natural language description. The prompt enhancement comprises machine-interpretable instructions configured to cause a large language model (LLM) to detect the safety event when the one or more conditions are satisfied. The instructions cause the system to integrate the prompt enhancement into a pre-deployed LLM prompt executing on at least one edge computing device associated with at least one vehicle to produce an integrated prompt. The integrated prompt is configured to detect one or more pre-existing safety events associated with the pre-deployed LLM prompt and the safety event in a unified execution pass of the LLM. The instructions cause the system to deploy the integrated prompt to the at least one edge computing device for processing sensor data captured by one or more sensors coupled to the at least one edge computing device to detect the safety event.

According to another aspect of the present disclosure, a method for managing a plurality of safety detection skills on an edge computing device of a vehicle is provided. The method comprises receiving, by a computing device, a request to deploy a new safety detection skill to the edge computing device. The edge computing device executes an on-device large language model operating according to a structured prompt comprising one or more pre-existing safety detection skills. The method comprises generating, by the computing device, a prompt enhancement corresponding to the new safety detection skill. The method comprises analyzing, by the computing device, the prompt enhancement in combination with prompt components corresponding to the one or more pre-existing safety detection skills to identify one or more overlapping conditions or shared sub-operations, and to detect one or more conflicts in at least one of resource utilization or detection logic. The method comprises generating, by the computing device, a dependency graph representing relationships among the new safety detection skill and the one or more pre-existing safety detection skills. The method comprises resolving, by the computing device, each detected conflict by performing at least one of: applying a prioritization rule designating a precedence order among conflicting skills, imposing a conditional activation constraint preventing concurrent evaluation of conflicting skills, or consolidating shared sub-operations to eliminate redundant processing. The method comprises producing a conflict-resolved integrated prompt incorporating the new safety detection skill and the one or more pre-existing safety detection skills. The conflict-resolved integrated prompt is deployable to the edge computing device for execution by the on-device large language model.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an implementation environment for a system and a method disclosed herein, in accordance with an embodiment of the present disclosure;

FIG. 2 illustrates a block diagram of a broad-level implementation environment for a system and the method disclosed herein, in accordance with an embodiment of the present disclosure;

FIG. 3 illustrates an example process flow for manually defining a desired safety detection skill, in accordance with an embodiment of the present disclosure;

FIG. 4 illustrates an example process flow for defining the desired safety detection skill using an agentic skill development process by the system, in accordance with an embodiment of the present disclosure;

FIG. 5 illustrates an example structure of a large language model (LLM) prompt of an on-device LLM, in accordance with an embodiment of the present disclosure;

FIG. 6 illustrates an example process flow for generating a prompt enhancement for a desired safety detection skill using the system, in accordance with an embodiment of the present disclosure;

FIG. 7 illustrates an example incorporation of one or more conditional activation logic associated with the desired safety detection skill, in accordance with an embodiment of the present disclosure;

FIG. 8 illustrates an example process flow for refining a prompt enhancement for deployment to an edge computing device, in accordance with an embodiment of the present disclosure;

FIG. 9 illustrates the process flow for conflict resolution and dependency management among a new safety detection skill and one or more pre-existing safety detection skills, in accordance with an embodiment of the present disclosure;

FIG. 10 illustrates example deployment architectures supported by the system for deploying the desired safety detection skill to the edge computing device, in accordance with an embodiment of the present disclosure;

FIG. 11 illustrates an example process flow for resource requirement estimation associated with each deployment architecture, in accordance with an embodiment of the present disclosure;

FIG. 12 illustrates an example process flow for implementing a piggybacking deployment option for the desired safety detection skill, in accordance with an embodiment of the present disclosure;

FIG. 13 illustrates an example process flow for generating deployment options for the desired safety detection skill, in accordance with an embodiment of the present disclosure;

FIG. 14 illustrates an example resource-based cost estimation process for determining a cost estimate associated with a deployment option, in accordance with an embodiment of the present disclosure;

FIG. 15 illustrates example value-based pricing factors considered in determining the cost estimate associated with the deployment option, in accordance with an embodiment of the present disclosure;

FIG. 16 illustrates example cost reduction techniques applicable to a cost structure of the deployment option, in accordance with an embodiment of the present disclosure;

FIG. 17 illustrates an example process flow for publishing the desired safety detection skill to a marketplace, in accordance with an embodiment of the present disclosure;

FIG. 18 illustrates an example revenue sharing model applicable to the desired safety detection skill published to the marketplace, in accordance with an embodiment of the present disclosure;

FIG. 19 illustrates an example process flow for customization and versioning of the desired safety detection skill obtained from the marketplace, in accordance with an embodiment of the present disclosure;

FIG. 20 illustrates example application programming interface (API) and integration capabilities, in accordance with an embodiment of the present disclosure;

FIG. 21 illustrates example security and privacy measures implemented by a system in accordance with an embodiment of the present disclosure;

FIG. 22 illustrates example workflow integration pathways triggered upon detection of a safety event by the system, in accordance with an embodiment of the present disclosure;

FIG. 23 illustrates an example end-to-end workflow for a construction site safety helmet detection safety detection skill, in accordance with an embodiment of the present disclosure;

FIG. 24 illustrates an example end-to-end workflow for a fuel spill detection safety detection skill, in accordance with an embodiment of the present disclosure;

FIG. 25 illustrates a flow chart depicting a method for deploying a custom detection skill to an edge computing device of a vehicle, according to an embodiment of the present disclosure;

FIG. 26 illustrates a flow chart depicting a method for managing a plurality of safety detection skills on the edge computing device of the vehicle, according to an embodiment of the present disclosure; and

FIG. 27 illustrates a block diagram of a system, in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

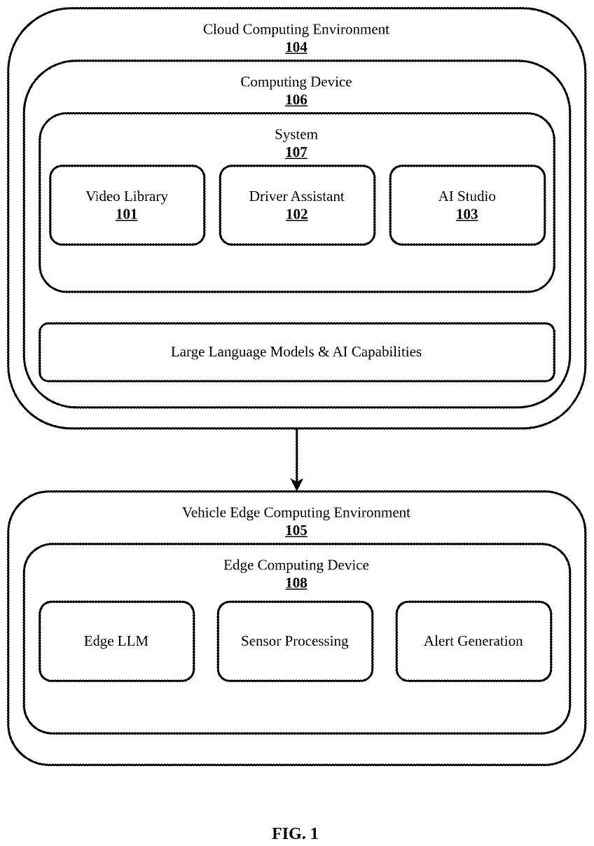

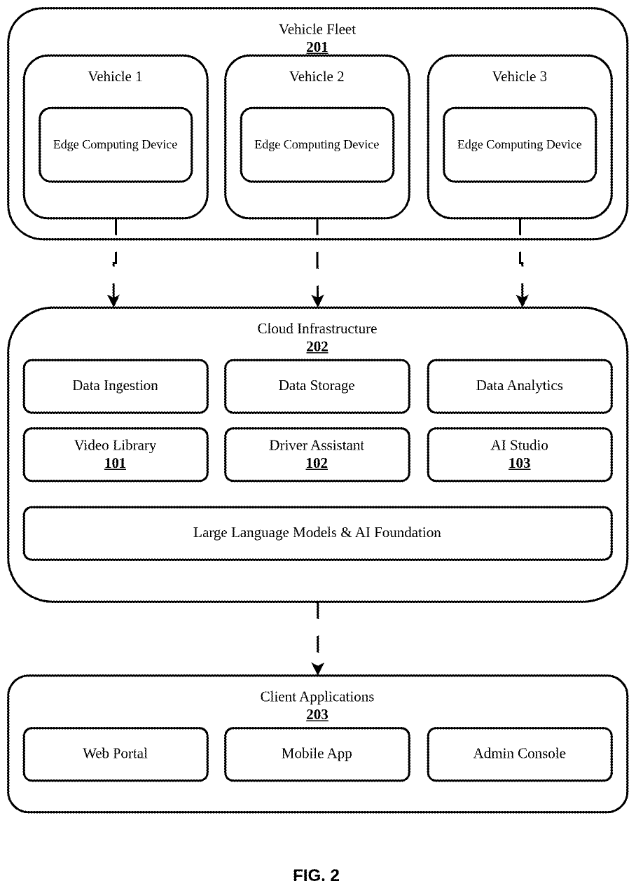

FIG. 1 illustrates a block diagram of an implementation environment for a system and a method disclosed herein, in accordance with an embodiment of the present disclosure. FIG. 2 illustrates a block diagram of a broader-level implementation environment for the system and the method disclosed herein, in accordance with another embodiment of the present disclosure.

In an embodiment, as illustrated in FIG. 1, the implementation environment may include a cloud computing environment 104 and a vehicle edge computing environment 105.

The cloud computing environment 104 may be a network-accessible computing infrastructure. The cloud computing environment 104 may provide on-demand computational resources, data storage, and software services over a communication network. The cloud computing environment 104 may include a computing device 106.

The computing device 106 may be a hardware-based computational unit. The computing device 106 may be implemented as one or more servers, virtual machines, or containerized processing units hosted within the cloud computing environment 104. The computing device 106 may be remotely accessible over the communication network by one or more authorized users. The computing device 106 may utilize one or more large language models (LLMs) and other artificial intelligence (AI) capabilities to perform steps of the method disclosed in the present disclosure.

In an embodiment, the one or more LLMs may be deep neural network-based language models trained on large corpora of text and multimodal data. Each LLM among the one or more LLMs may be configured to process natural language inputs and generate natural language outputs. Each LLM may additionally process structured inputs including but not limited to sensor data, image data, and video frame data. The AI capabilities of the computing device 106 may include but are not limited to computer vision, object detection, semantic segmentation, natural language understanding, natural language generation, and multimodal reasoning. The one or more LLMs and AI capabilities may be hosted as cloud-resident services on the computing device 106. The one or more LLMs may be accessible to downstream modules through application programming interfaces (APIs).

In an embodiment, the vehicle edge computing environment 105 may be a localized computing infrastructure deployed at a vehicle level. The vehicle edge computing environment 105 may be downstream to the cloud computing environment 104. The vehicle edge computing environment 105 may receive instructions, configurations, and prompts from the computing device 106 over the communication network.

The vehicle edge computing environment 105 may include at least one edge computing device 108 (hereinafter referred to as the edge computing device 108 for the sake of simplicity). The edge computing device 108 may be an onboard computational hardware unit mounted within or on a vehicle. The edge computing device 108 may be capable of performing one or more functions including but not limited to sensor data processing and alert generation. The edge computing device 108 may utilize an on-device large language model (alternatively referred to as the edge LLM) to perform the one or more functions.

The edge LLM may be a compressed or quantized variant of a large language model. The edge LLM may be optimized for execution under resource constraints. The resource constraints may include a memory constraint, a processing constraint, and a power consumption constraint of the edge computing device 108. The edge LLM may operate according to a structured prompt.

In an embodiment, the edge computing device 108 may maintain a temporal memory buffer. The temporal memory buffer may be a data structure configured to retain historical context of detections and sensor signals generated during preceding inference cycles of the on-device large language model. The temporal memory buffer may store detection results, sensor readings, and associated timestamps corresponding to a defined preceding time window. The temporal memory buffer may enable the on-device large language model to evaluate detection conditions that depend on temporal sequences of events, cumulative occurrence counts, or changes in detected states across successive inference cycles. For example, a safety detection skill directed to detecting repeated safety violations at a single location may utilize the temporal memory buffer to access detection results from preceding inference cycles to determine whether a threshold number of violations has been reached within a defined time period. The temporal memory buffer may operate within the memory constraint of the edge computing device 108 and may implement a first-in-first-out eviction policy to manage buffer capacity.

The structured prompt may define one or more safety detection skills executable by the edge LLM during processing of sensor data.

As used herein, the term “structured prompt” may refer to an organized prompt comprising a plurality of sections, each section serving a designated functional role in guiding analysis performed by an LLM.

Referring to FIG. 2, the broader-level implementation environment may include a fleet of vehicles 201. The fleet of vehicles 201 may include a plurality of vehicles. The plurality of vehicles may be connected over a vehicular communication network. Each vehicle among the plurality of vehicles may be configured with at least one dedicated edge computing device 108, as illustrated in FIG. 1.

In an embodiment, the fleet of vehicles 201 may be connected to a cloud infrastructure 202. The cloud infrastructure 202 may be implemented in the cloud computing environment 104. The cloud infrastructure 202 may be a collection of cloud-resident hardware and software resources. The cloud infrastructure 202 may provide capabilities including but not limited to data ingestion, data storage, and data analytics.

Data ingestion may refer to the capability of the cloud infrastructure 202 to receive and ingest sensor data, video data, and event data transmitted from the edge computing device 108 of each vehicle. Data storage may refer to the capability of the cloud infrastructure 202 to persistently retain the ingested data, processed results, skill definitions, and associated metadata in one or more storage units. Data analytics may refer to the capability of the cloud infrastructure 202 to perform statistical analysis, pattern recognition, and performance monitoring on the stored data.

In an embodiment, the cloud infrastructure 202 may also interface with one or more client applications 203. The one or more client applications 203 may be accessible to safety managers, fleet operators, and other authorized users. The one or more client applications 203 may include a web portal, a mobile app, and an admin console (collectively and individually referred to as a user).

The web portal may be a browser-accessible interface. The web portal may enable the user to configure, monitor, and manage safety detection skills deployed across the fleet of vehicles 201. The mobile app may be a software application executable on a mobile device. The mobile app may enable the user to receive real-time alerts and review detection records. The admin console may be a software interface. The admin console may enable an administrator to configure system-level parameters, manage user access, and monitor overall performance.

Referring to FIG. 1 and FIG. 2, in an embodiment, a system 107 for deploying safety detection skills in a vehicle may be implemented at the computing device 106. The method disclosed herein may therefore be performed by the computing device 106.

In an embodiment, the system 107 may interface with a video library 101, a driver assistant 102, and an AI studio 103. The system 107 may also interface with the LLMs and AI capabilities of the computing device 106. Alternatively, the system 107 may in-built with the video library 101, the driver assistant 102, and the AI studio 103.

The video library 101 may be a structured data repository. The video library 101 may store a plurality of video segments captured from one or more sensors coupled to vehicles in the fleet of vehicles 201. Each video segment among the plurality of video segments may be associated with metadata. The metadata may include date, time, geographic location, vehicle type, detected safety event, and user-defined tags. The video library 101 may support automated retrieval and manual retrieval of video segments. The video library 101 may utilize a vision-aligned LLM to perform automated tagging and indexing of video segments. The video library 101 may store de-identified data. De-identified data may refer to data in which vehicle-specific identifiers and driver-specific identifiers have been removed or anonymized.

The driver assistant 102 may be an agentic AI engine. The driver assistant 102 may be implemented as a software module executing on the computing device 106. The driver assistant 102 may utilize natural language processing capabilities of the one or more LLMs to interpret natural language descriptions received from the user. The driver assistant 102 may orchestrate backend processes including but not limited to video retrieval, video analysis, detection criteria generation, and deployment option generation. The driver assistant 102 may interface with the video library 101 to retrieve video segments. The driver assistant 102 may interface with the AI studio 103 to create and deploy safety detection skills. The driver assistant 102 may present results to the user through the one or more client applications 203.

The AI studio 103 may be a software development and deployment environment. The AI studio 103 may be implemented as a software module executing on the computing device 106. The AI studio 103 may provide an interactive alert builder interface to the user. The interactive alert builder interface may enable the user to define, test, and deploy safety detection skills without requiring programming expertise. The AI studio 103 may support manual skill definition and agentic skill development. The AI studio 103 may interface with the video library 101 to access video segments for skill development and testing.

In an embodiment, the edge computing device 108 may be configured to perform safety detection. Safety detection may refer to the automated identification of one or more safety events occurring in or around the vehicle during vehicle operation. A safety event may refer to an occurrence of a condition that poses a risk to the safety of a vehicle operator, a passenger, a pedestrian, or an object in proximity to the vehicle. Safety detection may be performed by the edge LLM executing on the edge computing device 108. The edge LLM may process sensor data captured by one or more sensors coupled to the edge computing device 108. The one or more sensors may include but are not limited to cameras, proximity sensors, and accelerometers. The edge LLM may analyze the sensor data according to a structured prompt to identify safety events.

In an embodiment, the structured prompt may define one or more safety detection skills. A safety detection skill may be a machine-interpretable instruction set. A safety detection skill may define a type of a safety event, one or more detection conditions for identifying the safety event, and one or more activation conditions under which the safety event is to be evaluated. The safety detection skill may further define an output action to be performed upon detection of the safety event. The output action may include but is not limited to generating a real-time alert, transmitting a notification, or recording a data segment. Each safety detection skill may be evaluated by the edge LLM during processing of sensor data.

As used herein, the term “machine-interpretable instructions” may refer to instructions formatted and structured such that an LLM can cause the at least one edge device on a vehicle parse and execute the instructions during an inference operation to perform a specified detection task.

In an embodiment, the edge computing device 108 may execute one or more pre-existing safety detection skills. The one or more pre-existing safety detection skills may be pre-configured by the operator. The one or more pre-existing safety detection skills may address common safety events. Common safety events may include but are not limited to distracted driving, speeding, and following distance violations.

In an embodiment, the safety manager or other authorized user may require detection of safety events beyond the one or more pre-existing safety detection skills. The safety manager may have safety requirements specific to an industry, an operational environment, or a regulatory framework. For example, a safety manager associated with a construction company may require detection of workers not wearing safety helmets at construction sites. A safety manager associated with a fuel delivery company may require detection of fuel spills during refueling operations. The one or more pre-existing safety detection skills may not address such industry-specific or environment-specific safety requirements.

Addressing such requirements may necessitate development of a new safety detection skill (alternatively referred to as a desired safety detection skill). Development of the new safety detection skill may traditionally require technical expertise in machine learning, computer vision, and software engineering. The safety manager may possess domain knowledge about the safety events to be detected. However, the safety manager may lack the technical expertise to translate domain knowledge into a functioning safety detection skill. Development of the new safety detection skill may involve lengthy requirements gathering, model development, and testing cycles. Conventionally, such cycles may extend over months or years before deployment.

As used herein, the term “custom detection skill” may refer to a user-defined detection capability created to address specific requirements beyond pre-existing detection capabilities. A custom detection skill may be developed by a user, such as a safety manager or fleet operator, to detect events or conditions particular to an industry, an operational environment, or a regulatory framework. The desired safety detection skill described throughout the present disclosure is an example of a custom detection skill. The systems and methods disclosed herein may be applied to custom detection skills directed to safety detection as well as to other vehicle-related applications including fleet management, operational compliance, and environmental monitoring.

Conventionally, even where the new safety detection skill may be developed and deployed to the edge computing device 108, the new safety detection skill may be implemented as a separate detection action. A separate detection action may execute independently of the one or more pre-existing safety detection skills. The independent execution of each safety detection skill may result in redundant processing operations on the edge computing device 108. Redundant processing operations may consume computational resources disproportionately. The edge computing device 108 may operate under a memory constraint, a processing constraint, and a power consumption constraint. Disproportionate consumption of computational resources may degrade the performance of the one or more pre-existing safety detection skills already executing on the edge computing device 108.

Further, deployment of a plurality of safety detection skills to the edge computing device 108 may further introduce conflicts in resource utilization or detection logic among the plurality of safety detection skills. Such conflicts may not be automatically identified or resolved in conventional implementation. Unresolved conflicts may result in missed detections, duplicate alerts, or system failures on the edge computing device 108.

Therefore, a need exists for the system 107 and the method that enable the safety manager or other authorized user to directly define and deploy a desired safety detection skill through a natural language description, without requiring technical expertise. A further need exists to enable detection of a plurality of safety events, including one or more pre-existing safety events and the safety event corresponding to the desired safety detection skill, in a unified execution pass of the edge LLM. The system 107 and the method disclosed herein address the foregoing needs.

In an embodiment, the system 107 may receive a natural language description of the desired safety detection skill. The natural language description may indicate a type of a safety event and one or more conditions for detection of the safety event. The natural language description may be received from the user through the one or more client applications 203.

In an embodiment, the system 107 may present the interactive alert builder interface to the user. The interactive alert builder interface may be presented through the AI studio 103. The system 107 may receive the natural language description through the interactive alert builder interface.

In an embodiment, the system 107 may receive a user selection of one or more target objects through the interactive alert builder interface. A target object among the one or more target objects may be an entity detectable within sensor data captured by the one or more sensors coupled to the edge computing device 108. The target object may include but is not limited to a person, a vehicle, an object, or any other structural element.

In an embodiment, the system 107 may further receive, through the interactive alert builder interface, a specification of at least one spatial relationship between two or more of the one or more target objects. The at least one spatial relationship may define a triggering condition for the safety event.

In an embodiment, the at least one spatial relationship may include an overlap condition The overlap condition may specify that a spatial overlap ratio between bounding regions of a first target object and a second target object exceeds an overlap threshold.

In an embodiment, the at least one spatial relationship may include a proximity condition. The proximity condition may specify that a distance metric between the first target object and the second target object is less than a distance threshold.

In an embodiment, the at least one spatial relationship may include a movement condition. The movement condition may specify that a change in relative position between the first target object and the second target object across successive frames satisfies a directional criterion.

In an embodiment, the spatial overlap ratio associated with the overlap condition may be computed as a ratio of an intersection area between bounding regions of the first target object and the second target object to a total area of the bounding region of the first target object. The intersection area may be determined by computing the geometric intersection of polygonal bounding regions corresponding to the first target object and the second target object within a video frame. The overlap threshold may be a configurable parameter specified by the user through the interactive alert builder interface. For example, an overlap threshold of seventy percent may indicate that the overlap condition is satisfied when the intersection area equals or exceeds seventy percent of the total area of the bounding region of the first target object.

In an embodiment, the distance metric associated with the proximity condition may be computed as a minimum pixel distance between polygonal bounding regions of the first target object and the second target object within a video frame. The minimum pixel distance may be determined by computing the shortest Euclidean distance between any point on the boundary of the bounding region of the first target object and any point on the boundary of the bounding region of the second target object. The distance threshold may be a configurable parameter specified by the user through the interactive alert builder interface. The distance threshold may be expressed as an absolute pixel distance or as a qualitative proximity level including but not limited to “very close,” “close,” and “near.”

In an embodiment, the directional criterion associated with the movement condition may be evaluated by computing a centroid distance between the first target object and the second target object across successive video frames. The centroid of each target object may be computed as the geometric center of the bounding region of the respective target object within each video frame. The movement condition may be satisfied when the centroid distance between the first target object and the second target object decreases across a defined number of successive video frames, indicating that the first target object is moving toward the second target object. The defined number of successive video frames may be a configurable parameter specified by the user through the interactive alert builder interface.

In an embodiment, the system 107 may enable the user to define the desired safety detection skill through a manual skill definition process. The manual skill definition process may be performed using the AI studio 103.

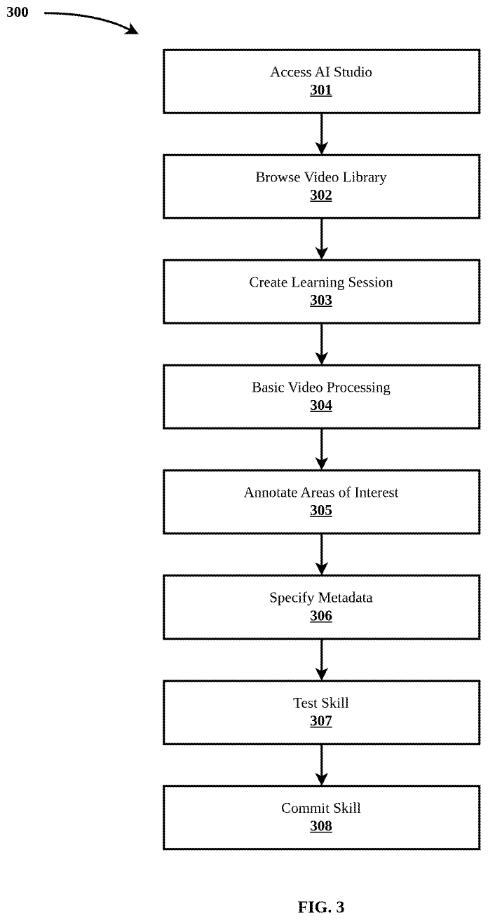

FIG. 3 illustrates an example process flow 300 for manually defining the desired safety detection skill using the system 107, in accordance with an embodiment of the present disclosure.

At step 301, the user may access the AI studio 103 through the one or more client applications 203. The user may initiate the manual skill definition process through the interactive alert builder interface.

At step 302, the user may browse the video library 101 to locate video segments relevant to the safety event to be detected. The video segments may include positive examples and negative examples. A positive example may be a video segment depicting an occurrence of the safety event. A negative example may be a video segment depicting a comparable situation in which the safety event does not occur. The user may search and filter the video library 101 using metadata including but not limited to date, geographic location, vehicle type, and user-defined tags.

At step 303, the user may create a new skill learning session within the AI studio 103. The new skill learning session may initiate a structured workflow. The structured workflow may guide the user through the subsequent steps of the manual skill definition process.

At step 304, the user may perform one or more video processing operations on the selected video segments. The one or more video processing operations may include adjusting brightness, adjusting contrast, or applying other processing parameters to highlight relevant features. The AI studio 103 may additionally provide automated enhancement capabilities to improve visibility of one or more target objects within the video segments.

At step 305, the user may annotate one or more areas of interest within the selected video segments. The annotation process may involve one or more of the following operations: selecting one or more target objects within a video frame, drawing bounding regions around the one or more target objects, highlighting specific regions of interest, or marking temporal points of interest within the video frames. The AI studio 103 may utilize the one or more LLMs to generate a description of detected content within the video frame. The user may review the generated description. The user may correct or refine the description by the system 107 regarding the one or more target objects. Through the annotation process, the user may additionally specify the at least one spatial relationship between two or more of the one or more target objects, as described above.

At step 306, the user may specify metadata associated with the desired safety detection skill through the interactive alert builder interface. The natural language description of the desired safety detection skill may be formed from the user selection of the one or more target objects, the specification of the at least one spatial relationship, and the metadata.

At step 307, the user may test the desired safety detection skill against one or more additional video segments from the video library 101. The user may review detection results generated during testing. Based on the detection results, the user may refine the desired safety detection skill. Refinement may involve adjusting one or more detection conditions, providing additional annotated examples, or modifying the at least one spatial relationship.

At step 308, upon achieving satisfactory detection performance, the user may commit the desired safety detection skill. The committed desired safety detection skill may be stored as a skill definition in the AI studio 103. The skill definition may be subsequently processed by the system 107 to generate a prompt enhancement, as described in the subsequent paragraphs of the present disclosure.

In an embodiment, the system 107 may alternatively receive the natural language description of the desired safety detection skill through an agentic skill development process. The agentic skill development process may be performed using the driver assistant 102 and the AI studio 103. The system 107 may receive the natural language description submitted by the user. The natural language description may describe the desired safety detection capability at a high level. The system 107 may autonomously process the natural language description to generate one or more detection criteria for the desired safety detection skill.

In an embodiment, the system 107 may dispatch the natural language description to an agentic AI engine. The agentic AI engine may be configured to search the video library 101 to retrieve a plurality of video segments relevant to the safety event described in the natural language description. The agentic AI engine may further analyze the plurality of video segments to identify one or more visual patterns. The one or more visual patterns may distinguish a compliant state from a non-compliant state across varying conditions. The varying conditions may include varying lighting conditions, varying weather conditions, varying camera angles, and varying degrees of occlusion. The agentic artificial intelligence engine may generate the one or more detection criteria based on the identified one or more visual patterns.

In an embodiment, the system 107 may present the one or more detection criteria and one or more sample detections to the user through the one or more client applications 203. The system 107 may receive feedback from the user. The agentic artificial intelligence engine may refine the one or more detection criteria based on the received feedback. The refined one or more detection criteria may form the natural language description of the desired safety detection skill. The natural language description may be subsequently processed by the system 107 to generate the prompt enhancement, as described in the subsequent paragraphs of the present disclosure.

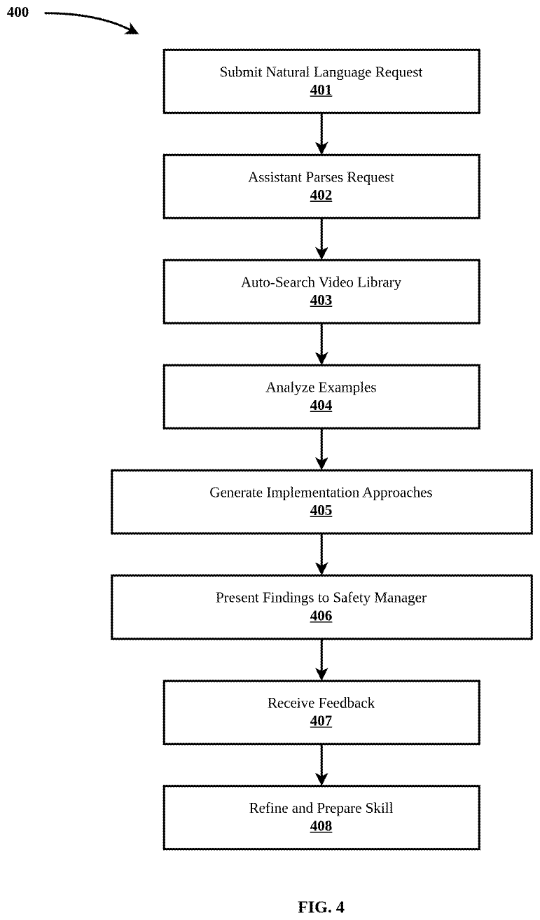

FIG. 4 illustrates an example process flow 400 for defining the desired safety detection skill using the agentic skill development process by the system 107, in accordance with an embodiment of the present disclosure.

At step 401, the user may submit a natural language request to the driver assistant 102 through the one or more client applications 203. The natural language request may describe the desired safety detection skill at a high level of abstraction. The natural language request may not require the user to specify technical parameters or detection conditions.

At step 402, the driver assistant 102 may parse the natural language request. Parsing the natural language request may involve identifying one or more target objects to be detected, a context associated with the safety event, and a detection goal corresponding to the desired safety detection skill. The driver assistant 102 may utilize the natural language processing capabilities of the one or more LLMs to perform parsing.

At step 403, based on the one or more target objects, the context, and the detection goal identified at step 402, the driver assistant 102 may automatically search the video library 101 to retrieve a plurality of video segments relevant to the safety event. The driver assistant 102 may utilize existing metadata, tags, and computer vision capabilities to identify relevant video segments. The driver assistant 102 may select a plurality of video segments covering varying conditions including varying lighting, varying weather, varying camera angles, and varying degrees of occlusion.

At step 404, the driver assistant 102 may analyze the plurality of video segments retrieved at step 403. The analysis may involve segmenting the video segments, identifying one or more target objects within each video segment, and determining one or more visual patterns that distinguish the compliant state from the non-compliant state. The driver assistant 102 may additionally identify environmental factors that may affect detection reliability.

At step 405, the driver assistant 102 may generate one or more implementation approaches based on the analysis performed at step 404. Each implementation approach among the one or more implementation approaches may represent a deployment option for the desired safety detection skill. Each deployment option may specify a deployment architecture, a resource requirement estimate, an expected performance metric, and a cost estimate. The one or more implementation approaches may include at least one of a cloud-based deployment option, an edge device deployment option, a hybrid deployment option, or a piggybacking deployment option. The one or more implementation approaches are further described in detail in subsequent paragraphs of the present disclosure.

At step 406, the driver assistant 102 may present findings to the user through the one or more client applications 203. The findings may include the one or more detection criteria, the one or more sample detections, the one or more implementation approaches, and associated cost estimates. The user may review the findings presented at step 406.

At step 407, the user may provide feedback to the driver assistant 102 through the one or more client applications 203. The feedback may include corrections to the one or more detection criteria, adjustments to the one or more activation conditions, or a selection among the one or more implementation approaches.

At step 408, the driver assistant 102 may refine the one or more detection criteria based on the feedback received at step 407. The refined one or more detection criteria may form the natural language description of the desired safety detection skill. The driver assistant 102 may prepare the desired safety detection skill for subsequent prompt enhancement generation and deployment by the system 107, as described in the subsequent paragraphs of the present disclosure.

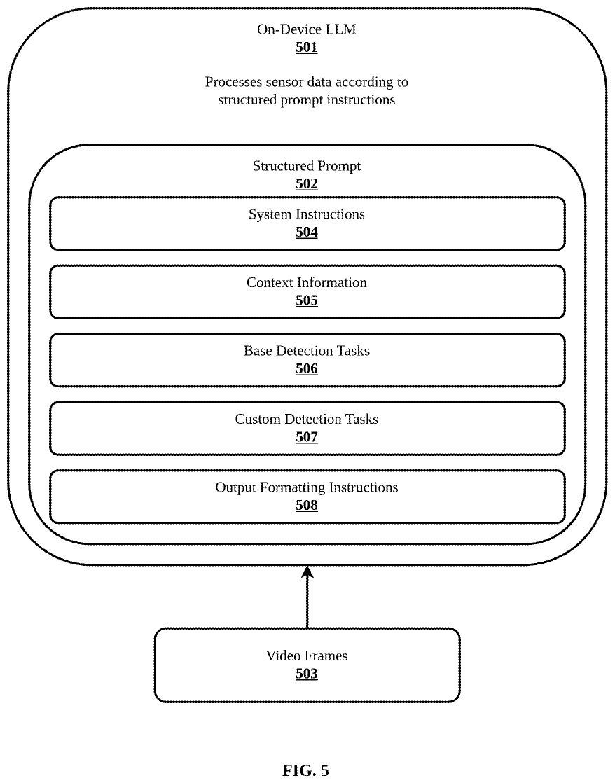

FIG. 5 illustrates an example structure of an LLM prompt of the on-device large language model, in accordance with an embodiment of the present disclosure.

In an embodiment, the edge computing device 108 may execute an on-device LLM 501. The on-device LLM 501 may process sensor data according to a pre-deployed LLM prompt. The sensor data may include video frames 503 captured by one or more sensors coupled to the edge computing device 108. The on-device LLM 501 may analyze the sensor data according to a pre-deployed LLM prompt to identify one or more safety events.

In an embodiment, the pre-deployed LLM prompt may be a structured prompt 502. The structured prompt 502 may be organized into a plurality of sections. Each section among the plurality of sections may serve a designated functional role in guiding the analysis performed by the on-device LLM 501. The structured prompt 502 may include a system instructions section 504, a context information section 505, a base detection task section 506, a custom detection task section 507, and output formatting instructions 508.

The system instructions section 504 may define the role and general operational parameters of the on-device LLM 501. The system instructions section 504 may specify the scope of analysis to be performed on the sensor data. The system instructions section 504 may further specify constraints governing the behavior of the on-device LLM 501 during inference.

The context information section 505 may provide situational information relevant to the analysis performed by the on-device LLM 501. The context information section 505 may include information about the vehicle, the operational environment, and current conditions. The context information section 505 may be updated dynamically based on data received from the edge computing device 108.

The base detection task section 506 may define one or more pre-existing safety events. A pre-existing safety event among the one or more pre-existing safety events may be a safety event that the on-device LLM 501 was initially deployed to detect. Pre-existing safety events may include but are not limited to distracted driving detection, seatbelt compliance detection, mobile phone use detection, and following distance violation detection. The base detection task section 506 may define the detection conditions, triggering conditions, and output actions associated with each pre-existing safety event. The base detection task section 506 may remain unmodified upon integration of the prompt enhancement as described in the subsequent paragraphs of the present disclosure.

The custom detection task section 507 may be a designated insertion point within the structured prompt 502. The custom detection task section 507 may be structurally separate from the base detection task section 506. The custom detection task section 507 may be specifically configured to receive one or more prompt enhancements corresponding to one or more desired safety detection skills. A prompt enhancement may be inserted into the custom detection task section 507 without modifying the base detection task section 506. The custom detection task section 507 may thereby enable new desired safety detection skills to be added to the structured prompt 502 without disturbing detection logic of the one or more pre-existing safety events defined in the base detection task section 506.

The output formatting instructions 508 may specify the structure and format of the output generated by the on-device LLM 501 upon completion of an inference pass. The output formatting instructions 508 may define how detection results, alert records, and associated metadata are to be structured for transmission to the computing device 106 or for local processing by the edge computing device 108.

In an embodiment, the structured prompt 502 may be specifically configured to enable the on-device LLM 501 to detect both the one or more pre-existing safety events defined in the base detection task section 506 and the safety event corresponding to the desired safety detection skill defined in the custom detection task section 507 in a unified execution pass. A unified execution pass may refer to a single inference pass of the on-device large language model 501 during which the on-device LLM 501 processes the sensor data against all detection tasks defined across the base detection task section 506 and the custom detection task section 507 simultaneously. The unified execution pass may eliminate the need for separate inference passes for each safety detection skill deployed to the edge computing device 108. The unified execution pass may thereby reduce computational resource consumption, memory utilization, and power consumption on the edge computing device 108.

As used herein, the term “unified execution pass” may refer to a single inference cycle of an LLM during which the LLM processes sensor data against all detection tasks defined in an integrated prompt simultaneously, without requiring separate inference passes for each safety detection skill.

Accordingly, the structured prompt 502 may provide the integration architecture into which the prompt enhancement corresponding to the desired safety detection skill may be inserted. The generation of the prompt enhancement and the integration of the prompt enhancement into the custom detection task section 507 of the structured prompt 502 are described in the subsequent paragraphs of the present disclosure.

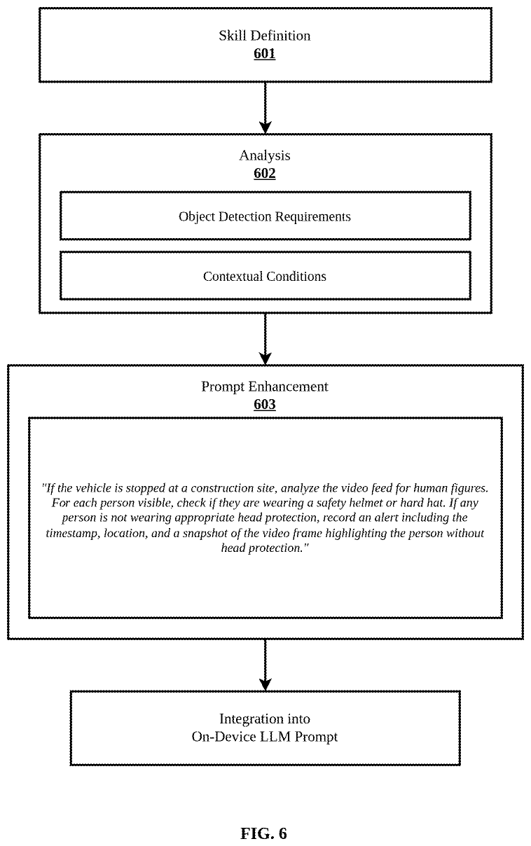

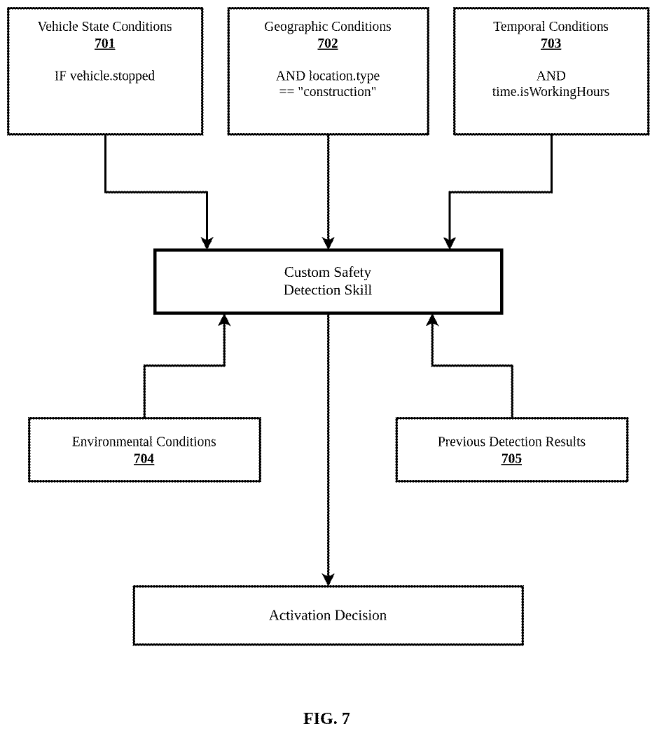

FIG. 6 illustrates an example process flow for generating the prompt enhancement for the desired safety detection skill using the system 107, in accordance with an embodiment of the present disclosure. The prompt enhancement is further described in reference to one or more conditional activation logic associated with the desired safety detection skills as illustrated in FIG. 7.

In an embodiment, the system 107 may generate the prompt enhancement based on the natural language description of the desired safety detection skill. The prompt enhancement may include machine-interpretable instructions. The machine-interpretable instructions may be configured to cause the on-device LLM 501 to detect the safety event when the one or more conditions specified in the natural language description are satisfied.

As used herein, the term “prompt enhancement” may refer to a machine-generated instruction set derived from a natural language description that encapsulates detection logic, activation conditions, and output specifications for a safety detection skill in a format compatible with an LLM prompt structure.

Referring to FIG. 6, at step 601, the system 107 may receive a skill definition corresponding to the desired safety detection skill. The skill definition may be formed from the natural language description received from the user.

At step 602, the system 107 may analyze the skill definition to identify elements to be included in the prompt enhancement. The analysis may identify object detection requirements and contextual conditions associated with the desired safety detection skill. Object detection requirements may specify the one or more target objects to be detected within the sensor data. Contextual conditions may specify the circumstances under which the detection of the safety event is to be evaluated.

At step 603, the system 107 may generate the prompt enhancement. The prompt enhancement may encapsulate the object detection requirements, the contextual conditions, the one or more activation conditions, and the decision criteria associated with the desired safety detection skill. The prompt enhancement may be structured in a format compatible with the structured prompt 502 executing on the on-device LLM 501.

In an embodiment, the system 107 may translate the natural language description into a machine-executable logic representation. The machine-executable logic representation may include one or more Boolean operators. The one or more Boolean operators may combine a plurality of detection conditions. Each detection condition among the plurality of detection conditions may correspond to at least one of a detected object state, a sensor reading threshold, or a spatial relationship between detected objects.

The detected object state may refer to a condition pertaining to the presence, absence, or configuration of a target object within the sensor data. The sensor reading threshold may refer to a condition pertaining to a measured value from one or more sensors meeting or exceeding a defined limit. A spatial relationship between detected objects may refer to a condition pertaining to the relative positions or movements of two or more target objects within the sensor data.

In an embodiment, the sensor reading threshold may correspond to a computed state variable associated with a target object or the edge computing device 108. A state variable may be a quantitative measurement derived from the sensor data during processing by the on-device large language model or by auxiliary processing modules of the edge computing device 108. State variables may include but are not limited to a speed of a target object, an area occupied by a target object within a video frame, a direction of movement of a target object, a color attribute of a target object, a position of the edge computing device 108 as determined by a Global Positioning System (GPS) receiver, a motion state of the edge computing device 108 as determined by an inertial measurement unit (IMU), or an orientation of one or more sensors coupled to the edge computing device 108. A detection condition referencing a sensor reading threshold may specify that the state variable meets or exceeds a defined limit, falls below a defined limit, or falls within a defined range.

The one or more Boolean operators may include AND operators, OR operators, and NOT operators. The machine-executable logic representation may thereby express the detection logic of the desired safety detection skill in a form directly interpretable by the on-device LLM 501.

In an embodiment, the system 107 may serialize the machine-executable logic representation and one or more associated object embeddings into a structured portable data format. An object embedding may be a vector representation of the target object. The object embedding may encode visual and semantic characteristics of the target object in a form processable by the on-device LLM 501. The structured portable data format may be a schema-compliant data format. The structured portable data format may include but is not limited to a JavaScript Object Notation (JSON) based schema or an equivalent structured representation. The serialized structured portable data format may be transmitted to the edge computing device 108 for integration into the structured prompt 502.

In an embodiment, the system 107 may generate conditional activation logic as part of the prompt enhancement. The conditional activation logic may indicate one or more activation conditions under which the desired safety detection skill is to be evaluated by the on-device LLM 501. The one or more activation conditions may include at least one of a vehicle state condition, a geographic condition, a temporal condition, an environmental condition, or a prior detection condition.

The prompt enhancement may be structured such that the on-device LLM 501 bypasses evaluation of the desired safety detection skill when the one or more activation conditions are not satisfied. The conditional activation logic may thereby ensure that computational resources of the edge computing device 108 are consumed only when the context associated with the sensor data satisfies the one or more activation conditions.

Accordingly, the system 107 may generate the prompt enhancement comprising the machine-interpretable instructions, the machine-executable logic representation, the one or more associated object embeddings, and the conditional activation logic. The generated prompt enhancement may be subsequently integrated into the pre-deployed LLM prompt, as described in the subsequent paragraphs.

FIG. 7 illustrates an example incorporation of the one or more conditional activation logic associated with the desired safety detection skill by the system 107, in accordance with an embodiment of the present disclosure. The one or more conditional activation logic may govern the conditions under which the desired safety detection skill is evaluated by the on-device LLM 501 during processing of sensor data.

In an embodiment, the one or more activation conditions may include at least one of a vehicle state condition 701, a geographic condition 702, a temporal condition 703, an environmental condition 704, or a prior detection condition 705. Each activation condition among the one or more activation conditions may be evaluated by the on-device LLM 501 prior to evaluation of the desired safety detection skill. Upon satisfaction of the one or more activation conditions, the on-device LLM 501 may proceed to evaluate the desired safety detection skill. Upon non-satisfaction of the one or more activation conditions, the on-device LLM 501 may bypass evaluation of the desired safety detection skill.

The vehicle state condition 701 may specify a state of the vehicle under which the desired safety detection skill is to be activated. The vehicle state condition 701 may be expressed as a logical predicate evaluable from sensor data available to the edge computing device 108. The vehicle state condition 701 may include but is not limited to a condition specifying that the vehicle is stationary, a condition specifying that the vehicle speed exceeds a defined threshold, a condition specifying that the vehicle is executing a turning maneuver, or a condition specifying that the vehicle is operating in reverse. For example, a desired safety detection skill directed to construction site safety helmet compliance may specify a vehicle state condition 701 requiring that the vehicle be stationary prior to activation.

The geographic condition 702 may specify a location-based criterion under which the desired safety detection skill is to be activated. The geographic condition 702 may be expressed as a logical predicate evaluable from location data available to the edge computing device 108. The geographic condition 702 may include but is not limited to a condition specifying that the vehicle is within a defined geofenced boundary, a condition specifying that the vehicle is in proximity to a specific category of location, or a condition specifying that the vehicle location matches one or more stored coordinates. For example, a desired safety detection skill directed to construction site safety helmet compliance may specify a geographic condition 702 requiring that the vehicle location correspond to a known construction site or exhibit visual characteristics of a construction environment.

The temporal condition 703 may specify a time-based criterion under which the desired safety detection skill is to be activated. The temporal condition 703 may be expressed as a logical predicate evaluable from time data available to the edge computing device 108. The temporal condition 703 may include but is not limited to a condition specifying a time of day range, a condition specifying one or more days of the week, or a condition specifying a defined calendar period. For example, a desired safety detection skill directed to construction site safety helmet compliance may specify a temporal condition 703 requiring that the current time fall within designated working hours.

The environmental condition 704 may specify an environmental state under which the desired safety detection skill is to be activated. The environmental condition 704 may be expressed as a logical predicate evaluable from sensor data and environmental metadata available to the edge computing device 108. The environmental condition 704 may include but is not limited to a condition specifying a minimum ambient lighting level, a condition specifying a weather state such as rain or fog, or a condition specifying a minimum visibility threshold. For example, a desired safety detection skill directed to pedestrian detection may specify an environmental condition 704 requiring that ambient lighting exceeds a defined threshold to ensure detection reliability.

The prior detection condition 705 may specify a condition based on one or more detection results previously generated by the on-device LLM 501 under which the desired safety detection skill is to be activated. The prior detection condition 705 may include but is not limited to a condition specifying that a defined pre-existing safety event has been detected within a preceding time window, or a condition specifying that a defined alert threshold has been reached within a preceding operational period. The prior detection condition 705 may enable a desired safety detection skill to be activated as a follow-on skill upon occurrence of a pre-existing safety event. For example, a desired safety detection skill directed to verifying driver response to a proximity alert may specify a prior detection condition 705 requiring that a proximity-related pre-existing safety event has been detected within a defined preceding time window.

In an embodiment, the one or more activation conditions may be combined through one or more Boolean operators within the conditional activation logic. The combined activation conditions may form a composite activation predicate. The on-device LLM 501 may evaluate the desired safety detection skill only upon satisfaction of the composite activation predicate. The conditional activation logic may thereby minimize unnecessary inference operations on the edge computing device 108 and optimize utilization of available computational resources.

Accordingly, the prompt enhancement generated by the system 107 may include the conditional activation logic defining the one or more activation conditions. The prompt enhancement comprising the conditional activation logic may be subsequently integrated into the pre-deployed LLM prompt executing on the edge computing device 108, as described in the subsequent paragraphs.

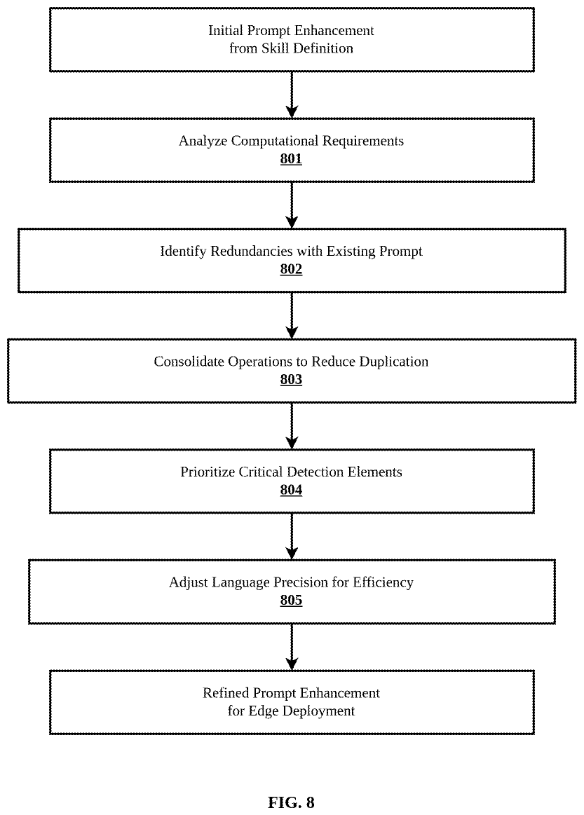

FIG. 8 illustrates an example process flow for refining the prompt enhancement for deployment to the edge computing device 108, in accordance with an embodiment of the present disclosure.

The prompt enhancement generated by the system 107 may be derived from the natural language description of the desired safety detection skill. The edge computing device 108 may operate under the memory constraint, the processing constraint, and a power consumption constraint. A prompt enhancement that is not refined to operate within the resource constraints of the edge computing device 108 may degrade the performance of one or more pre-existing safety detection skills executing on the edge computing device 108. Accordingly, prior to integration of the prompt enhancement into the pre-deployed LLM prompt, the system 107 may refine the prompt enhancement to operate within the resource constraints of the edge computing device 108 while preserving detection accuracy for the safety event.

In an embodiment, the system 107 may determine the one or more resource constraints of the edge computing device 108. The system 107 may determine the one or more resource constraints by querying a hardware profile associated with the edge computing device 108. The hardware profile may specify the available memory capacity, the processing capacity, and the power consumption budget of the edge computing device 108. The hardware profile may be stored at the computing device 106 and may be updated upon changes to the hardware configuration of the edge computing device 108.

As used herein, the term “hardware profile” may refer to a specification of the computational capabilities and resource constraints of an edge computing device, including available memory capacity, processing capacity, power consumption budget, processor model, and on-device LLM version.

The memory constraint may specify a maximum quantity of memory available to the on-device LLM 501 for storing the structured prompt 502 and intermediate inference results. The processing constraint may specify a maximum computational throughput available to the on-device LLM 501 for executing inference operations within a defined latency budget. The power consumption constraint may specify a maximum power draw permissible.

Referring to FIG. 8, at step 801, the system 107 may analyze the computational requirements of the prompt enhancement. The analysis may determine the token count of the prompt enhancement, the inference latency introduced by the prompt enhancement, and the memory footprint of the prompt enhancement when loaded into the structured prompt 502. The system 107 may compare the determined computational requirements against the one or more resource constraints of the edge computing device 108.

At step 802, the system 107 may identify redundancies between the prompt enhancement and the existing components of the structured prompt 502. A redundancy may exist where the prompt enhancement specifies a detection operation that is already performed by the base detection task section 506 or by another prompt enhancement previously inserted into the custom detection task section 507. The system 107 may catalog each identified redundancy for consolidation at the subsequent step.

At step 803, the system 107 may consolidate operations to reduce duplication within the structured prompt 502. Consolidating operations may involve replacing redundant detection operations in the prompt enhancement with references to detection results already generated by the base detection task section 506 or other components of the structured prompt 502. Consolidating operations may reduce the token count and inference overhead of the prompt enhancement without removing detection functionality.

At step 804, the system 107 may prioritize detection elements within the prompt enhancement based on the one or more resource constraints. Detection elements may be classified as critical detection elements or non-critical detection elements. A critical detection element may be a detection condition whose removal would prevent detection of the safety event. A non-critical detection element may be a detection condition that supplements detection accuracy without being essential for detection of the safety event. Where the resource constraints of the edge computing device 108 require further reduction in the computational requirements of the prompt enhancement, the system 107 may retain critical detection elements and may reduce or remove non-critical detection elements.

At step 805, the system 107 may adjust the language precision of the prompt enhancement to reduce token overhead. Adjusting language precision may involve replacing verbose natural language instructions within the prompt enhancement with concise machine-interpretable equivalents. Adjusting language precision may further involve removing redundant qualifiers, consolidating multi-step instructions into single instructions, and standardizing terminology to align with the vocabulary of the on-device LLM 501. Adjustments to language precision may be performed such that the semantic content of the prompt enhancement is preserved and detection accuracy for the safety event is maintained.

The output of the process illustrated in FIG. 8 may be a refined prompt enhancement. The refined prompt enhancement may be configured to operate within the memory constraint, the processing constraint, and the power consumption constraint of the edge computing device 108 while preserving detection accuracy for the safety event.

In an embodiment, the refinement process illustrated in FIG. 8 may further include testing the refined prompt enhancement against simulated or historical sensor data to verify that detection accuracy for the safety event is preserved after refinement. Where the refined prompt enhancement does not achieve a defined detection accuracy threshold, the system 107 may perform one or more additional refinement iterations. The system 107 may additionally identify tradeoffs between detection accuracy and resource utilization and may present the identified tradeoffs to the user through the one or more client applications 203.

The refined prompt enhancement may be subsequently integrated into the pre-deployed LLM prompt executing on the edge computing device 108, as described in the following section.

In an embodiment, the system 107 may integrate the refined prompt enhancement into the pre-deployed LLM prompt executing on the edge computing device 108. Integration of the refined prompt enhancement into the pre-deployed LLM prompt may produce an integrated prompt. The integration of the refined prompt enhancement may include refining the prompt enhancement to operate within the memory constraint, the processing constraint, and the power consumption constraint of the edge computing device 108 while preserving detection accuracy for the safety event. The integrated prompt may configure the on-device LLM 501 to detect both the one or more pre-existing safety events and the safety event corresponding to the desired safety detection skill.

In an embodiment, the system 107 may integrate the refined prompt enhancement into the pre-deployed LLM prompt by inserting the refined prompt enhancement into the custom detection task section 507 of the structured prompt 502, as illustrated in FIG. 5. The insertion of the refined prompt enhancement into the custom detection task section 507 may be performed without modifying the base detection task section 506 of the structured prompt 502. The base detection task section 506 may retain the detection conditions, triggering conditions, and output actions associated with the one or more pre-existing safety events in an unmodified state. The one or more pre-existing safety events defined in the base detection task section 506 may thereby continue to execute without alteration following integration of the refined prompt enhancement.

In an embodiment, the custom detection task section 507 may accommodate a plurality of prompt enhancements corresponding to a plurality of desired safety detection skills. Each prompt enhancement among the plurality of prompt enhancements may occupy a separate entry within the custom detection task section 507.

In an embodiment, the result of the integration process may be the integrated prompt. The integrated prompt may be configured to cause the on-device large LLM 501 to detect the one or more pre-existing safety events and the safety event corresponding to the desired safety detection skill in a unified execution pass.

In an embodiment, the unified execution pass may eliminate the requirement for separate inference passes for each safety detection skill executing on the edge computing device 108. A separate inference pass for each safety detection skill may require the on-device LLM 501 to independently load, process, and unload detection instructions for each safety detection skill. Independent loading, processing, and unloading of detection instructions for each safety detection skill may multiply the memory utilization, processing overhead, and power consumption of the edge computing device 108 in proportion to the number of safety detection skills deployed. The unified execution pass of the integrated prompt may avoid such multiplication of resource consumption by enabling the on-device LLM 501 to process all detection tasks defined in the integrated prompt within a single inference cycle.

In an embodiment, the unified execution pass may further provide detection coherence across the base detection task section 506 and the custom detection task section 507. Detection coherence may refer to the ability of the on-device LLM 501 to apply detection results from the base detection task section 506 as contextual inputs to the evaluation of detection conditions defined in the custom detection task section 507 within the same inference pass.

In an embodiment, the edge computing device 108 may, over time, accumulate a plurality of safety detection skills within the custom detection task section 507 of the structured prompt 502. A new safety detection skill requested for deployment to the edge computing device 108 may interact with one or more pre-existing safety detection skills already executing on the edge computing device 108. Such interactions may introduce overlapping conditions, shared sub-operations, or conflicts in resource utilization or detection logic among the plurality of safety detection skills. The system 107 may identify and resolve such interactions prior to deployment of the new safety detection skill to the edge computing device 108.

In an embodiment, the system 107 may receive a request to deploy a new safety detection skill to the edge computing device 108.

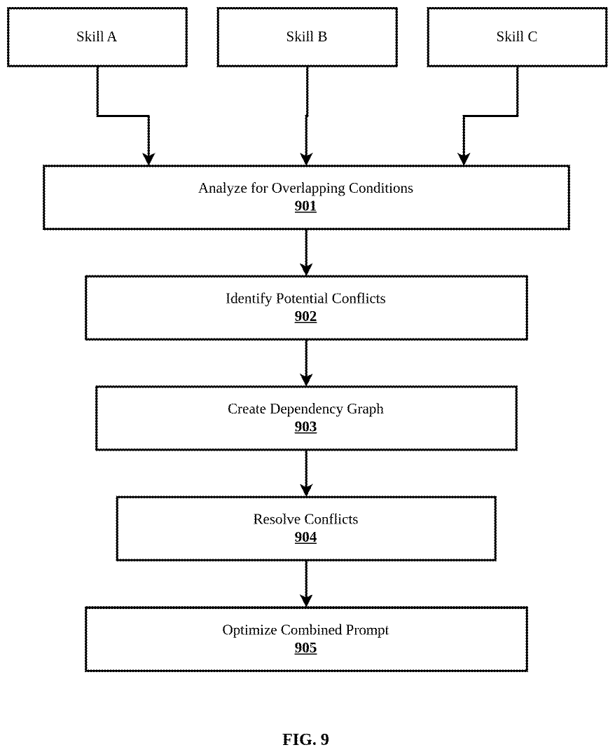

FIG. 9 illustrates the process flow for conflict resolution and dependency management among the new safety detection skill and the one or more pre-existing safety detection skills, in accordance with an embodiment of the present disclosure.

At step 901, the system 107 may analyze the prompt enhancement corresponding to the new safety detection skill in combination with the prompt components corresponding to the one or more pre-existing safety detection skills for overlapping conditions or shared sub-operations. An overlapping condition may exist where the new safety detection skill and one or more pre-existing safety detection skills specify identical or substantially similar detection conditions, triggering conditions, or activation conditions. A shared sub-operation may exist where the new safety detection skill and one or more pre-existing safety detection skills require a common processing operation to be performed on the sensor data, such as detection of a common object type or evaluation of a common spatial relationship.

At step 902, the system 107 may identify one or more conflicts among the new safety detection skill and the one or more pre-existing safety detection skills. A conflict in resource utilization may exist where concurrent evaluation of the new safety detection skill and one or more pre-existing safety detection skills may cause the combined resource consumption of the structured prompt 502 to exceed the memory constraint, the processing constraint, or the power consumption constraint of the edge computing device 108. A conflict in detection logic may exist where the new safety detection skill and one or more pre-existing safety detection skills may generate contradictory detection outputs for the same sensor data input, or where the activation of one safety detection skill may interfere with the correct evaluation of another safety detection skill.

At step 903, the system 107 may generate a dependency graph representing relationships among the new safety detection skill and the one or more pre-existing safety detection skills. The dependency graph may include a plurality of nodes and a plurality of edges. Each node among the plurality of nodes may represent a safety detection skill among the new safety detection skill and the one or more pre-existing safety detection skills. Each edge among the plurality of edges may represent a relationship between two safety detection skills connected by the edge. A relationship represented by an edge may include a shared detection condition, a shared sub-operation, a resource dependency, or a detected conflict in detection logic. The dependency graph may provide a structured data representation of the interactions among the plurality of safety detection skills. The dependency graph may enable the system 107 to systematically identify and address each detected conflict at the subsequent step.

As used herein, the term “dependency graph” may refer to a data structure comprising nodes representing safety detection skills and edges representing relationships among the safety detection skills, including shared detection conditions, shared sub-operations, resource dependencies, or conflicts in detection logic.

At step 904, the system 107 may resolve each detected conflict identified at step 902. The system 107 may resolve each detected conflict by implementing at least one of a prioritization rule, or a conditional activation constraint. The prioritization rule may specify that where two or more safety detection skills generate conflicting detection outputs for the same sensor data input, the detection output of the safety detection skill having the higher precedence in the precedence order may govern. The precedence order may be determined based on factors including but not limited to the safety criticality of each safety detection skill, the regulatory requirements associated with each safety detection skill, or a user-specified priority assignment. The conditional activation constraint may specify that a second safety detection skill among the conflicting safety detection skills may be evaluated only when a first safety detection skill among the conflicting safety detection skills has not been triggered during the same inference pass of the on-device LLM 501. The conditional activation constraint may thereby prevent conflicting safety detection skills from simultaneously consuming the processing resources of the edge computing device 108 and may prevent conflicting detection outputs from being simultaneously generated. Additionally, the system 107 may resolve a detected conflict by consolidating shared sub-operations among the new safety detection skill and one or more pre-existing safety detection skills. Where the new safety detection skill and at least one pre-existing safety detection skill each require detection of a common object type, the system 107 may consolidate the detection operation for the common object type into a single shared detection operation.

At step 905, the system 107 may optimize the combined structured prompt 502 to handle all safety detection skills efficiently following conflict resolution. The output of step 905 may be a conflict-resolved integrated prompt. The conflict-resolved integrated prompt may incorporate the new safety detection skill and the one or more pre-existing safety detection skills in a single coherent structured prompt. The conflict-resolved integrated prompt may be deployable to the edge computing device 108 for execution by the on-device large language model 501.

As used herein, the term “conflict-resolved integrated prompt” may refer to an integrated prompt in which conflicts among a plurality of safety detection skills have been resolved through prioritization rules, conditional activation constraints, or consolidation of shared sub-operations.

In an embodiment, the system 107 may monitor one or more performance metrics of the integrated prompt on the edge computing device 108 following deployment. The one or more performance metrics may include detection accuracy for each safety detection skill, inference latency, memory utilization, and power consumption of the edge computing device 108. The system 107 may identify at least one performance degradation attributable to the new safety detection skill based on the monitored one or more performance metrics. Upon identifying at least one performance degradation, the system 107 may refine at least one of the prompt enhancement corresponding to the new safety detection skill or the prioritization rule applied during conflict resolution to remediate the at least one performance degradation. The refined prompt enhancement or prioritization rule may be reintegrated into the conflict-resolved integrated prompt and redeployed to the edge computing device 108.

In an embodiment, the system 107 may deploy the integrated prompt to the at least one edge computing device 108 for processing sensor data captured by the one or more sensors coupled to the at least one edge computing device to detect the safety event.

In an alternate embodiment, the system 107 may deploy the integrated prompt to the plurality of edge computing devices associated with the fleet of vehicles 201.

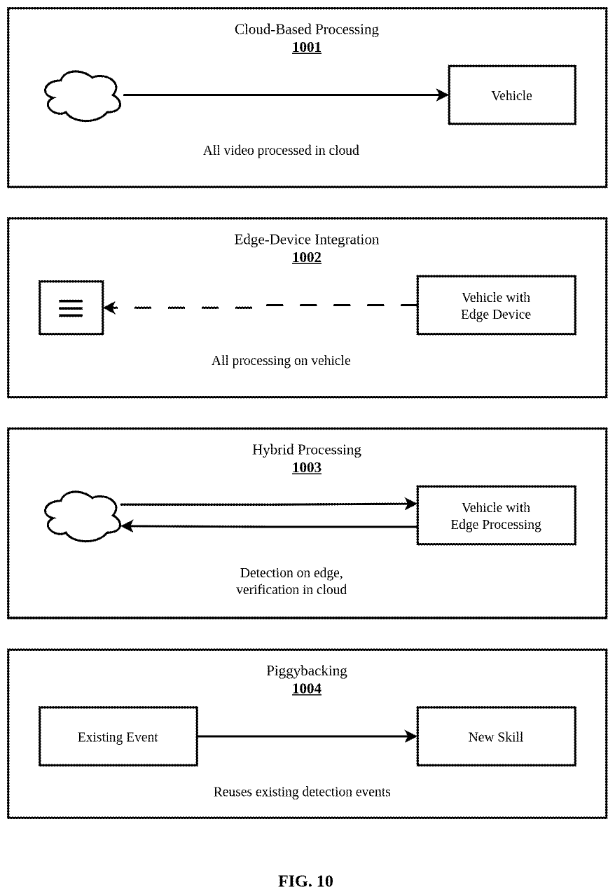

FIG. 10 illustrates example deployment architectures supported by the system 107 for deploying the desired safety detection skill to the edge computing device 108, in accordance with an embodiment of the present disclosure.

In an embodiment, prior to deploying the integrated prompt to the edge computing device 108, the system 107 may generate a plurality of deployment options for the desired safety detection skill. The plurality of deployment options may reflect different approaches to executing the desired safety detection skill. Each deployment option among the plurality of deployment options may specify a deployment architecture, a resource requirement estimate, an expected performance metric, and a cost estimate. The system 107 may present the plurality of deployment options to the user through the one or more client applications 203. The user may select one deployment option among the plurality of deployment options. The system 107 may deploy the integrated prompt based on the selected deployment option.

In an embodiment, the plurality of deployment options may include at least two of a cloud-based deployment option 1001, an edge device deployment option 1002, a hybrid deployment option 1003, or a piggybacking deployment option 1004.

The cloud-based deployment option 1001 may indicate a deployment architecture in which sensor data captured by the one or more sensors coupled to the edge computing device 108 may be transmitted to the cloud computing environment 104 upon satisfaction of the one or more activation conditions. The desired safety detection skill may be evaluated by the LLM executing on the computing device 106 in the cloud computing environment 104. Detection results and alerts may be transmitted from the computing device 106 to the edge computing device 108 and to the one or more client applications 203. The cloud-based deployment option 1001 may be suitable for desired safety detection skills having a high computational intensity that may exceed the processing constraint of the edge computing device 108. The cloud-based deployment option 1001 may involve a higher bandwidth cost due to data transfer requirements between the edge computing device 108 and the cloud computing environment 104.

The edge device deployment option 1002 may indicate a deployment architecture in which the integrated prompt may execute entirely on the on-device LLM 501 of the edge computing device 108. The desired safety detection skill may be evaluated locally by the on-device LLM 501 without requiring data transmission to the cloud computing environment 104. Detection results and alerts may be generated locally by the edge computing device 108 and synchronized with the cloud computing environment 104 when network connectivity may be available. The edge device deployment option 1002 may be suitable for desired safety detection skills having a computational intensity within the processing constraint of the edge computing device 108. The edge device deployment option 1002 may provide lower detection latency and may operate independently of network connectivity.

The hybrid deployment option 1003 may indicate a deployment architecture in which an initial detection operation may be performed by the on-device LLM 501 of the edge computing device 108, and a verification operation may be performed by an LLM executing on the computing device 106 in the cloud computing environment 104. The edge computing device 108 may identify candidate safety events based on initial detection conditions. Sensor data associated with candidate safety events may be transmitted to the cloud computing environment 104 for verification. Confirmed safety events may generate alerts that may be transmitted to the one or more client applications 203. The hybrid deployment option 1003 may reduce the data transfer requirements 1103 relative to the cloud-based deployment option 1001 by limiting data transmission to candidate safety events rather than continuous sensor data streams.

The piggybacking deployment option 1004 may indicate a deployment architecture in which the desired safety detection skill may be activated upon occurrence of the one or more pre-existing detection events associated with the pre-deployed LLM prompt. The piggybacking deployment option 1004 may be generated by identifying the one or more pre-existing detection events that share at least one common triggering condition with the desired safety detection skill, and by configuring the desired safety detection skill to activate upon occurrence of the one or more pre-existing detection events. The piggybacking deployment option 1004 may reduce the computational overhead of the edge computing device 108.

In an embodiment, the system 107 may analyze the resource analysis results corresponding to the desired safety detection skill to generate the plurality of deployment options. Each deployment option among the plurality of deployment options may specify a deployment architecture, a resource requirement estimate, an expected performance metric, and a cost estimate. The plurality of deployment options may be analyzed to produce one or more implementation recommendations. The system 107 may present the plurality of deployment options and the one or more implementation recommendations to the user through the one or more client applications 203. The system 107 may receive a selection of one deployment option among the plurality of deployment options from the user. The system 107 may deploy the integrated prompt based on the selected deployment option.

In an embodiment, the system 107 may estimate the resource requirements associated with each deployment.

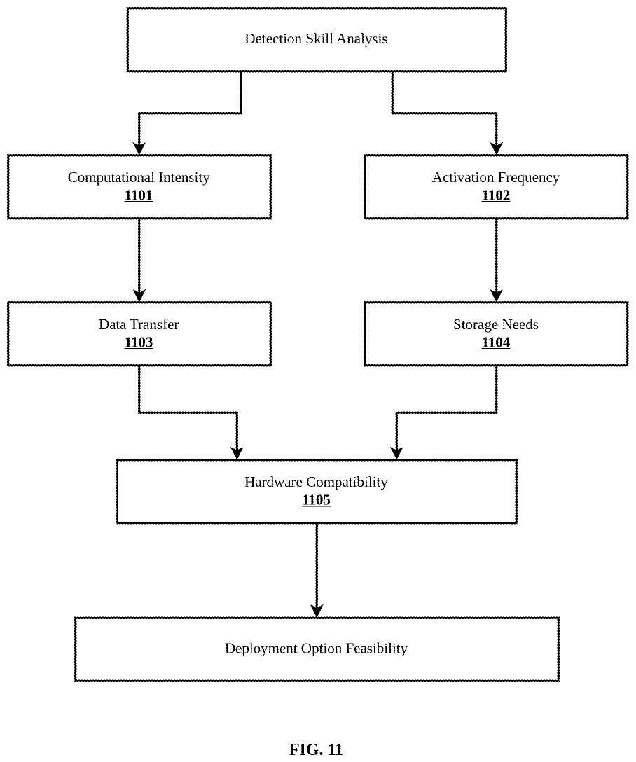

FIG. 11 illustrates an example process flow for resource requirement estimation associated with each deployment architecture, in accordance with an embodiment of the present disclosure.

The resource requirement estimation may begin with a detection skill analysis of the desired safety detection skill.

In an embodiment, a computational intensity 1101 may refer to the processing load imposed by the desired safety detection skill per inference cycle. The computational intensity 1101 may be estimated based on the number of target objects to be detected, the complexity of the one or more detection conditions, and the token count of the prompt enhancement.

In an embodiment, an activation frequency 1102 may refer to the expected rate at which the desired safety detection skill may be activated during vehicle operation. The activation frequency 1102 may be estimated based on the one or more activation conditions specified in the conditional activation logic and on historical sensor data from vehicles in the fleet of vehicles 201.

In an embodiment, data transfer requirements 1103 may refer to the volume of sensor data required to be transmitted between the edge computing device 108 and the cloud computing environment 104 per activation of the desired safety detection skill. The data transfer requirements 1103 may vary depending on the deployment architecture selected.

In an embodiment, storage needs 1104 may refer to the volume of data required to be retained on the edge computing device 108 or in the cloud computing environment 104 to support the desired safety detection skill. The storage needs 1104 may be estimated based on the expected activation frequency 1102 and the data segment size associated with each detection event.

In an embodiment, the hardware compatibility 1105 may refer to the compatibility of the desired safety detection skill with a hardware profile of the edge computing device 108. The hardware profile of each edge computing device may specify the available memory capacity, the processing capacity, and the power consumption budget of the edge computing device. The hardware compatibility 1105 may be assessed by comparing the computational intensity 1101 and storage needs 1104 of the desired safety detection skill against the resource constraints of the edge computing device 108. The hardware compatibility 1105 assessment may determine the feasibility of each deployment architecture for the edge computing device 108.

In an embodiment, the combined assessment of the computational intensity 1101, the activation frequency 1102, the data transfer requirements 1103, the storage needs 1104, and the hardware compatibility 1105 may produce a deployment option feasibility determination for each deployment architecture. The deployment option feasibility determination may be used by the system 107 to generate the plurality of deployment options and associated cost estimates.

In an embodiment, the system 107 may identify the one or more pre-existing detection events associated with the pre-deployed LLM prompt that share at least one common triggering condition with the desired safety detection skill. The system 107 may configure the piggybacking deployment option to activate the desired safety detection skill upon occurrence of the one or more pre-existing detection events.

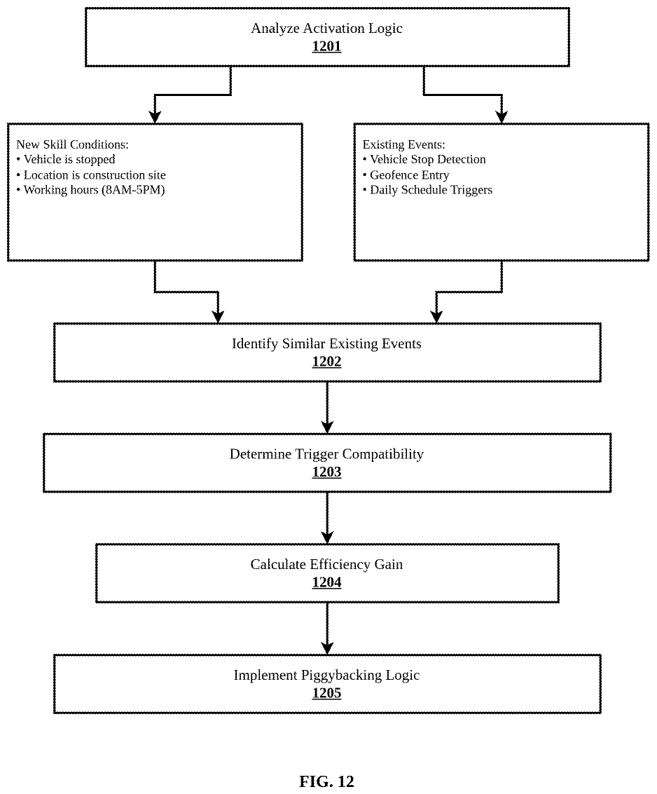

FIG. 12 illustrates an example process flow for implementing the piggybacking deployment option for a desired safety detection skill, in accordance with an embodiment of the present disclosure.

At step 1201, the system 107 may analyze the conditional activation logic of the desired safety detection skill. The analysis may identify the one or more activation conditions specified in the conditional activation logic.

At step 1202, the system 107 may identify the one or more pre-existing detection events associated with the pre-deployed LLM prompt that share at least one common triggering condition with the desired safety detection skill. For example, a pre-existing vehicle stop detection event may share a common triggering condition with a desired safety detection skill specifying a vehicle state condition 701 requiring that the vehicle be stationary.

At step 1203, the system 107 may determine the compatibility of the desired safety detection skill with each identified pre-existing detection event. Compatibility may be determined by assessing whether the triggering condition of the pre-existing detection event may reliably indicate satisfaction of the one or more activation conditions of the desired safety detection skill. The system 107 may further assess whether activation of the desired safety detection skill upon occurrence of the pre-existing detection event may result in detection accuracy for the safety event equivalent to that achievable through an independent activation mechanism.

At step 1204, the system 107 may calculate the efficiency gain resulting from implementing the piggybacking deployment option 1004 for the desired safety detection skill. The efficiency gain may be expressed as a reduction in the activation frequency 1102 of the desired safety detection skill relative to an independent activation mechanism, a reduction in the computational overhead of the edge computing device 108, and a reduction in the cost estimate associated with the deployment option.

At step 1205, the system 107 may implement a piggybacking logic for the desired safety detection skill. Implementing the piggybacking logic may involve configuring the conditional activation logic of the desired safety detection skill to evaluate the desired safety detection skill upon occurrence of the one or more identified pre-existing detection events. The piggybacking logic may be incorporated into the prompt enhancement corresponding to the desired safety detection skill.

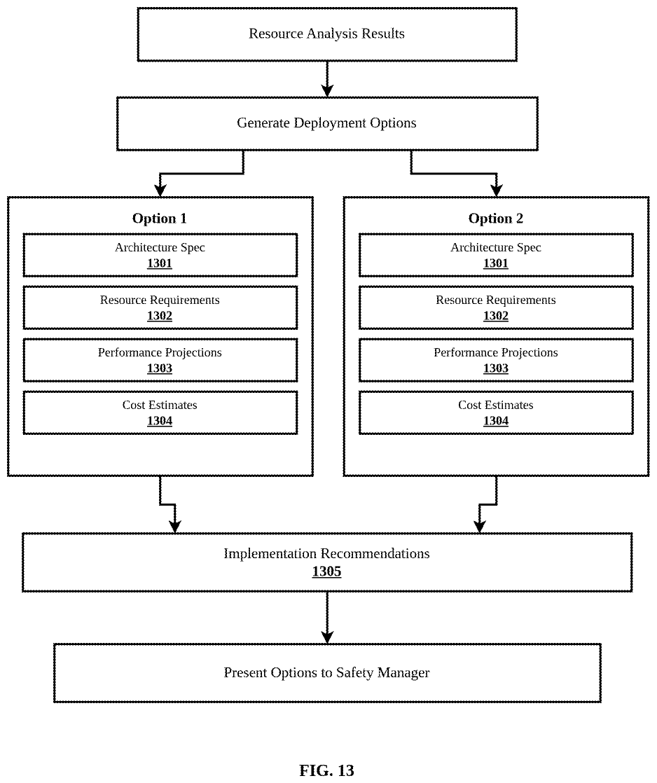

FIG. 13 illustrates an example process flow for generating deployment options for the desired safety detection skill, in accordance with an embodiment of the present disclosure.

In an embodiment, the system 107 may generate the plurality of deployment options for the desired safety detection skill prior to deploying the integrated prompt to the edge computing device 108. Each deployment option among the plurality of deployment options may represent a distinct approach to executing the desired safety detection skill.

In an embodiment, the system 107 may utilize the resource analysis results corresponding to the desired safety detection skill for generation of the plurality of deployment options. Each deployment option among the plurality of deployment options may specify a deployment architecture 1301, a resource requirement estimate 1302, a performance projection 1303, and a cost estimate 1304.

The deployment architecture 1301 may specify the computing environment in which the desired safety detection skill may be executed. The deployment architecture 1301 may correspond to one of the deployment architectures described in reference to FIG. 10. The deployment architecture 1301 may specify at least one of the cloud-based deployment option 1001, the edge device deployment option 1002, the hybrid deployment option 1003, or the piggybacking deployment option 1004.

The resource requirement estimate 1302 may specify the estimated memory consumption, processing load, bandwidth consumption, and power consumption associated with executing the desired safety detection skill under the specified deployment architecture 1301. The resource requirement estimate 1302 may be derived from the computational intensity 1101, activation frequency 1102, data transfer requirements 1103, storage needs 1104, and hardware compatibility 1105 determined during the resource requirement estimation illustrated in FIG. 11.

The performance projection 1303 may specify the expected detection accuracy, detection latency, and reliability of the desired safety detection skill under the specified deployment architecture 1301. The performance projection 1303 may be estimated based on the computational resources available under the specified deployment architecture 1301 and the computational requirements of the desired safety detection skill.

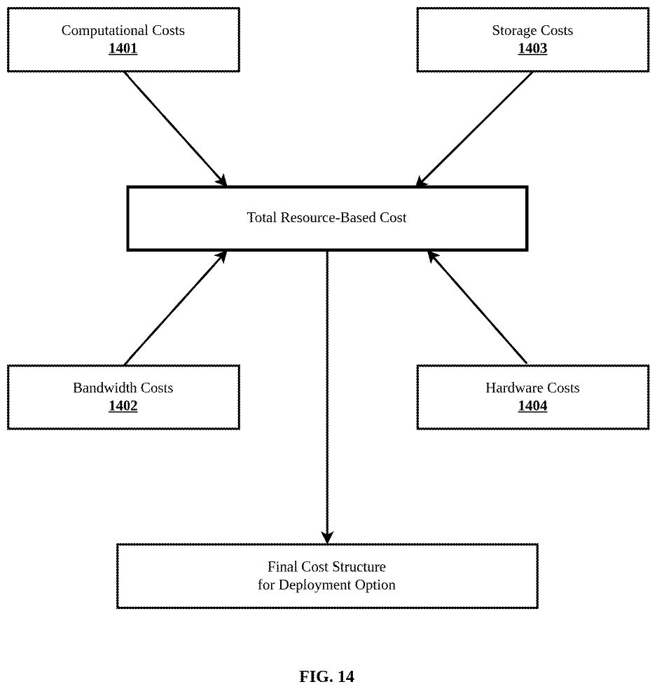

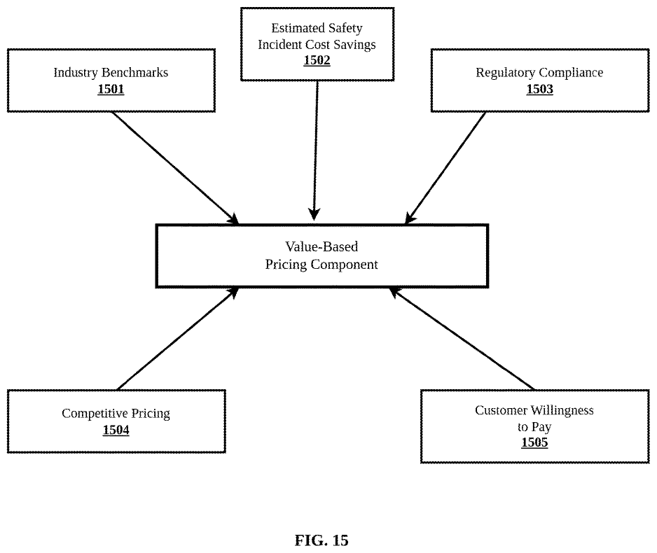

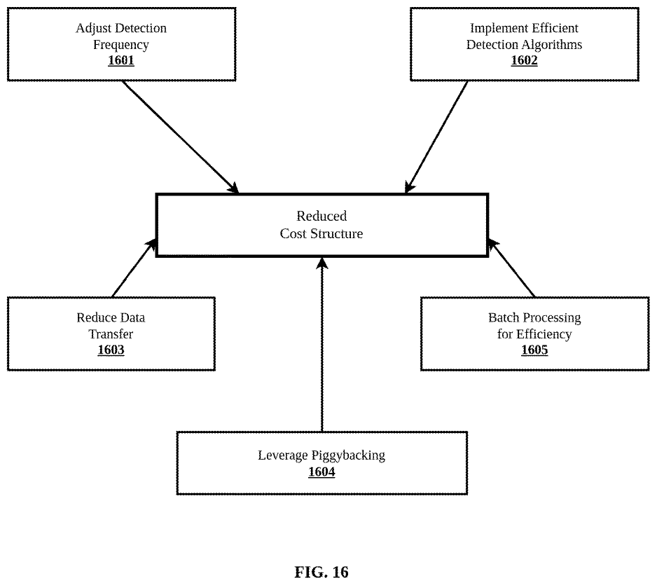

The cost estimate 1304 may specify the total estimated cost of deploying and operating the desired safety detection skill under the specified deployment architecture 1301. The cost estimate 1304 may incorporate the resource-based cost components illustrated in FIG. 14 and the value-based pricing factors illustrated in FIG. 15. The cost estimate 1304 may further reflect cost reductions achievable through the cost reduction techniques illustrated in FIG. 16.

The system 107 may analyze the plurality of deployment options to produce one or more implementation recommendations 1305. The one or more implementation recommendations 1305 may identify the deployment option among the plurality of deployment options that may best satisfy the user's operational requirements, resource constraints, and budget constraints. The one or more implementation recommendations 1305 may be generated based on a weighted assessment of the deployment architecture 1301, resource requirement estimate 1302, performance projection 1303, and cost estimate 1304 of each deployment option.

The system 107 may present the plurality of deployment options and the one or more implementation recommendations 1305 to the user through the one or more client applications 203. The user may review the plurality of deployment options and the one or more implementation recommendations 1305. The system 107 may receive a selection of one deployment option among the plurality of deployment options from the user. The system 107 may deploy the integrated prompt based on the selected deployment option.

In an embodiment, the system 107 may generate a cost estimate for each deployment option among the plurality of deployment options. The cost estimate may include a resource-based cost component and a value-based pricing component.

FIG. 14 illustrates an example resource-based cost estimation process for determining a cost estimate associated with a deployment option, in accordance with an embodiment of the present disclosure.

In an embodiment, the resource-based cost component may be calculated based on computational costs 1401, bandwidth costs 1402, storage costs 1403, and hardware costs 1404.

Computational costs 1401 may be based on the processing time and computational resources consumed by the desired safety detection skill per activation, multiplied by the estimated activation frequency 1102. Bandwidth costs 1402 may be based on the volume of data transferred between the edge computing device 108 and the cloud computing environment 104 per activation of the desired safety detection skill. Storage costs 1403 may be based on the volume of data retained in the video library 101 or on the edge computing device 108 to support the desired safety detection skill. Hardware costs 1404 may include one-time costs for any additional hardware required to support the selected deployment architecture and recurring costs for ongoing hardware utilization. The combined computational costs 1401, bandwidth costs 1402, storage costs 1403, and hardware costs 1404 may form a total resource-based cost. The total resource-based cost may form a cost structure for the deployment option.

FIG. 15 illustrates example value-based pricing factors considered in determining the cost estimate associated with the deployment option, in accordance with an embodiment of the present disclosure.

The value-based pricing component may reflect the business value of the desired safety detection skill to the user. The value-based pricing component may be determined based on industry benchmarks 1501 for the safety event addressed by the desired safety detection skill, estimated safety incident cost savings 1502 from prevention of the safety event, regulatory compliance value 1503 associated with the desired safety detection skill, competitive pricing 1504 for comparable safety detection capabilities, and customer willingness to pay 1505 based on the industry and safety criticality of the desired safety detection skill.

FIG. 16 illustrates example cost reduction techniques applicable to the cost structure of the deployment option, in accordance with an embodiment of the present disclosure.

The system 107 may apply one or more cost reduction techniques to reduce the cost estimate associated with a deployment option while maintaining acceptable detection performance. The one or more cost reduction techniques may include adjusting detection frequency 1601, implementing efficient detection algorithms 1602, reducing data transfer 1603, leveraging piggybacking 1604, or batch processing 1605. Adjusting detection frequency 1601 may involve modifying the activation conditions of the desired safety detection skill to reduce unnecessary activations. Implementing efficient detection algorithms 1602 may involve substituting computationally intensive detection operations with computationally equivalent operations having reduced processing overhead. Reducing data transfer 1603 may involve applying compression or selective upload techniques to reduce the bandwidth costs 1402 associated with cloud-based or hybrid deployment architectures. Leveraging piggybacking 1604 may involve applying the piggybacking deployment option 1004 to reduce the activation frequency 1102 and associated computational costs 1401. Batch processing 1605 may involve aggregating detection operations across multiple sensor data frames to reduce the per-frame computational overhead of the desired safety detection skill.

Accordingly, the system 107 may generate the plurality of deployment options for the desired safety detection skill. Each deployment option may specify the deployment architecture, the resource requirement estimate, the expected performance metric, and the cost estimate. The system 107 may present the plurality of deployment options to the user through the one or more client applications 203. Upon receiving a selection of one deployment option from the user, the system 107 may deploy the integrated prompt based on the selected deployment option

The system 107 may deploy the integrated prompt to the edge computing device 108 of a single vehicle based on the selected deployment option. The system 107 may additionally deploy the integrated prompt to a plurality of edge computing devices associated with the fleet of vehicles 201, as illustrated in FIG. 2. Fleet-wide deployment may enable the desired safety detection skill to operate across all vehicles in the fleet of vehicles 201 simultaneously. Fleet-wide deployment may present challenges arising from differing hardware profiles across the plurality of edge computing devices in the fleet of vehicles 201. The system 107 may address such challenges by adapting the integrated prompt for each edge computing device based on the respective hardware profile of the edge computing device.

In an embodiment, prior to deploying the integrated prompt to each edge computing device among the plurality of edge computing devices, the system 107 may determine the hardware profile for each edge computing device. The hardware profile may further specify the model and generation of the processor installed on the edge computing device, the version of the on-device large language model executing on the edge computing device, and any hardware accelerators available to the edge computing device. The hardware profile of each edge computing device may be stored at the computing device 106. The hardware profile of each edge computing device may be updated upon changes to the hardware configuration of the edge computing device or upon installation of updated on-device large language model versions.

In an embodiment, the plurality of edge computing devices in the fleet of vehicles 201 may not share a uniform hardware profile. A first subset of edge computing devices among the plurality of edge computing devices may operate on a first hardware tier having a first set of resource constraints. A second subset of edge computing devices among the plurality of edge computing devices may operate on a second hardware tier having a second set of resource constraints differing from the first set of resource constraints. The differing resource constraints across the fleet of vehicles 201 may require the integrated prompt to be adapted independently for each hardware tier to ensure that the desired safety detection skill may operate within the resource constraints of each edge computing device.

In an embodiment, the system 107 may adapt the integrated prompt for each edge computing device based on the respective hardware profile of the edge computing device. The adaptation may preserve the detection logic, the detection conditions, the conditional activation logic, and the conflict resolution outcomes of the integrated prompt across all adapted versions.

In an embodiment, the system 107 may transmit each adapted version of the integrated prompt to the corresponding subset of edge computing devices having the matching hardware profile. The system 107 may maintain a record of the adapted version of the integrated prompt deployed to each edge computing device in the fleet of vehicles 201. Upon a subsequent modification to the desired safety detection skill or upon the addition of a new safety detection skill to the integrated prompt, the system 107 may generate updated adapted versions of the integrated prompt for each hardware tier and may redeploy the updated adapted versions to the corresponding edge computing devices in the fleet of vehicles 201.

Accordingly, the system 107 may deploy the integrated prompt across the fleet of vehicles 201 in a hardware-aware manner. The detection logic of the desired safety detection skill may be preserved uniformly across the fleet of vehicles 201 while the computational encoding of the integrated prompt may be optimized for the resource constraints of each respective edge computing device.

In an embodiment, upon deployment of the integrated prompt to the edge computing device 108, the on-device large language model 501 may process sensor data captured by the one or more sensors coupled to the edge computing device 108 in the unified execution pass. Upon detection of the safety event corresponding to the desired safety detection skill during the unified execution pass, the system 107 may perform one or more post-detection actions. The one or more post-detection actions may be configured during deployment of the desired safety detection skill. The one or more post-detection actions may include generating a real-time alert to an operator of the vehicle, transmitting a notification to a remote safety management application, recording the detection and an associated data segment for subsequent review, and creating a coaching record associated with the detection.

In an embodiment, following deployment of the desired safety detection skill to the fleet of vehicles 201, the system 107 may enable the user to publish the desired safety detection skill to a marketplace. The marketplace may be a software platform accessible to a plurality of users. The marketplace may enable a first user to make the desired safety detection skill available to a second user. The second user may deploy the desired safety detection skill published by the first user to a second fleet of vehicles. The second user may additionally create a derivative version of the desired safety detection skill by modifying one or more parameters of the desired safety detection skill. The marketplace may thereby facilitate knowledge sharing and accelerate the adoption of safety detection skills across organizations.

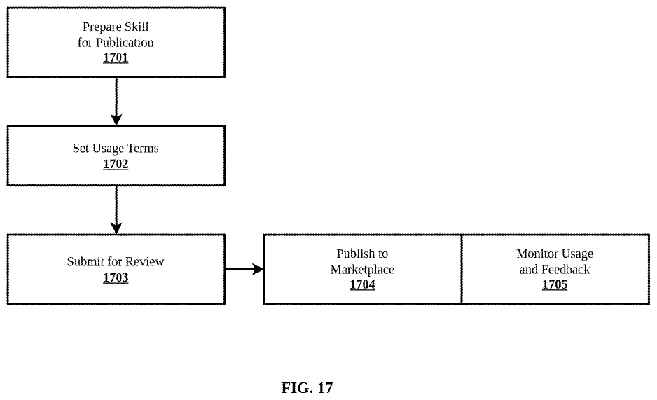

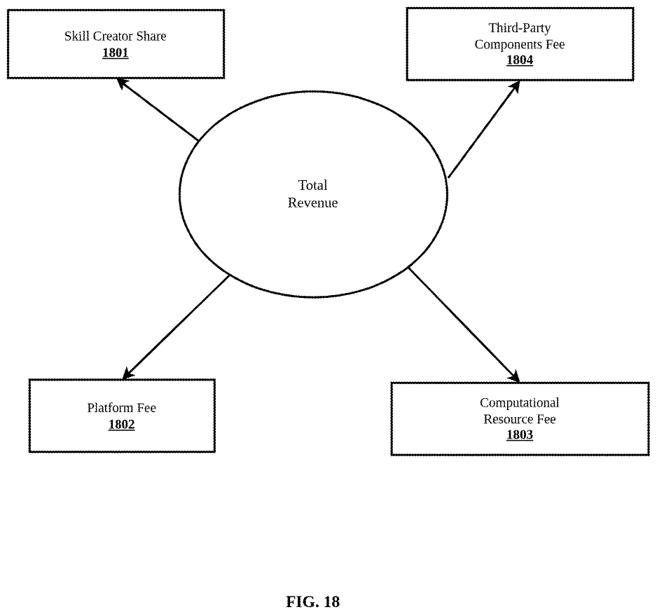

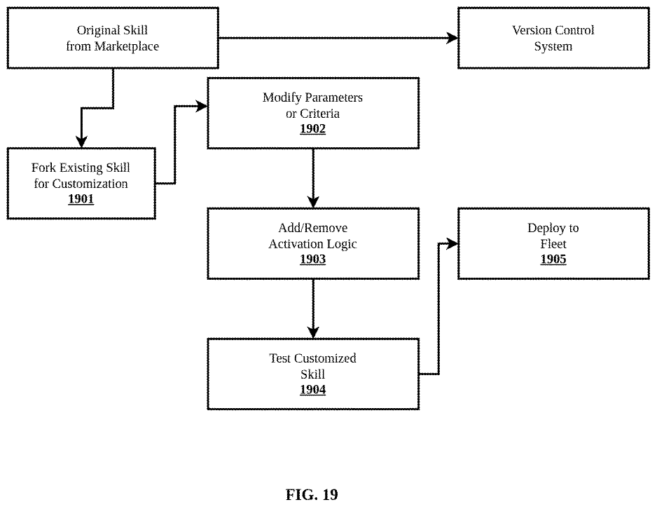

FIG. 17 illustrates an example process flow for publishing the desired safety detection skill to a marketplace, in accordance with an embodiment of the present disclosure. FIG. 18 illustrates an example revenue sharing model applicable to the desired safety detection skill published to the marketplace, in accordance with an embodiment of the present disclosure. FIG. 19 illustrates an example process flow for customization and versioning of the desired safety detection skill obtained from the marketplace, in accordance with an embodiment of the present disclosure.

In an embodiment, the system 107 may enable the user to publish the desired safety detection skill to the marketplace. The marketplace may be accessible to the plurality of users through the one or more client applications 203.

At step 1701, the user may prepare the desired safety detection skill for publication. Preparing the desired safety detection skill for publication may involve documenting the purpose of the desired safety detection skill, the one or more detection conditions associated with the desired safety detection skill, the one or more activation conditions associated with the desired safety detection skill, the resource requirements of the desired safety detection skill, and the expected performance metrics of the desired safety detection skill. The prepared documentation may be associated with the desired safety detection skill in the marketplace to enable prospective users to evaluate the suitability of the desired safety detection skill for their operational requirements.

At step 1702, the user may set usage terms for the desired safety detection skill. The usage terms may specify the conditions under which the desired safety detection skill may be accessed, deployed, or modified by other users through the marketplace. The usage terms may include pricing terms, attribution requirements, and restrictions on derivative versions of the desired safety detection skill.

At step 1703, the user may submit the desired safety detection skill for review. The review process may assess the quality and compliance of the desired safety detection skill with marketplace standards. The review process may verify that the desired safety detection skill may perform detection at a defined accuracy level, may operate within specified resource constraints, and may not conflict with applicable safety or privacy requirements. Upon successful completion of the review process, the desired safety detection skill may be approved for publication to the marketplace.

At step 1704, the system 107 may publish the approved desired safety detection skill to the marketplace. The published desired safety detection skill may be accessible to a plurality of users through the marketplace. A user accessing the marketplace may browse, search, and filter published safety detection skills by safety event type, industry, activation conditions, resource requirements, and cost.

At step 1705, the system 107 may monitor usage of the published desired safety detection skill and may collect feedback from users who have deployed the desired safety detection skill. The usage monitoring may track the number of deployments, the detection performance of the desired safety detection skill across different fleets of vehicles, and user-reported observations. The collected feedback may be made available to the publishing user to support subsequent refinement of the desired safety detection skill.

In an embodiment, the system 107 may implement a revenue sharing model for desired safety detection skills offered commercially through the marketplace. The revenue sharing model may allocate total revenue generated from commercial deployment of the desired safety detection skill among a plurality of recipients.

Referring to FIG. 18, a skill creator share 1801 may be allocated to the user who published the desired safety detection skill to the marketplace. The skill creator share 1801 may compensate the publishing user for the development and maintenance of the desired safety detection skill. The skill creator share 1801 may be calculated as a defined proportion of the total revenue generated from deployments of the desired safety detection skill through the marketplace.

A platform fee 1802 may be allocated to the operator of the marketplace. The platform fee 1802 may cover the costs of hosting, distributing, and administering the desired safety detection skill through the marketplace. The platform fee 1802 may be calculated as a defined proportion of the total revenue generated from deployments of the desired safety detection skill.

A computational resource fee 1803 may be allocated to cover the costs of computational resources consumed during execution of the desired safety detection skill. The computational resource fee 1803 may be calculated based on the resource requirement estimate associated with the desired safety detection skill and the activation frequency of the desired safety detection skill across deployed fleets of vehicles.

A third-party components fee 1804 may be allocated where the desired safety detection skill incorporates one or more third-party components or services. The third-party components fee 1804 may cover licensing or usage costs associated with the incorporated third-party components or services.

The revenue sharing model may thereby provide a financial incentive for users to develop and publish safety detection skills to the marketplace. The revenue sharing model may further support a self-sustaining commercial ecosystem for the marketplace.

In an embodiment, the system 107 may enable the second user to create a derivative version of the desired safety detection skill published to the marketplace by the first user. The second user may create the derivative version by modifying at least one of one or more detection parameters, one or more activation conditions, or one or more detection thresholds of the desired safety detection skill.

Referring to FIG. 19, at step 1901, the second user may fork the desired safety detection skill from the marketplace to create a derivative version. Forking may involve creating an independent copy of the desired safety detection skill that may be modified by the second user without affecting the original desired safety detection skill published by the first user. The system 107 may track the relationship between the original desired safety detection skill and the derivative version, may record the modifications applied to the derivative version, and may facilitate attribution of the derivative version to the original desired safety detection skill.

At step 1902, the second user may modify the one or more detection parameters or detection criteria of the forked desired safety detection skill through the interactive alert builder interface of the AI studio 103.

At step 1903, the second user may add or remove conditional activation logic associated with the forked desired safety detection skill.

At step 1904, the second user may test the derivative version of the desired safety detection skill against video segments from the video library 101. The second user may review detection results generated during testing. Based on the detection results, the second user may perform additional modifications to the one or more detection parameters, detection criteria, or conditional activation logic of the derivative version. Upon achieving satisfactory detection performance, the second user may commit the derivative version as a new desired safety detection skill.

At step 1905, the second user may deploy the derivative version of the desired safety detection skill to a second fleet of vehicles. The system 107 may maintain a record of the deployed derivative version and the relationship between the derivative version and the original desired safety detection skill published by the first user.

Accordingly, the marketplace may enable the first user to publish the desired safety detection skill for access by the plurality of users. The second user may deploy the desired safety detection skill to the second fleet of vehicles or may create the derivative version of the desired safety detection skill. The marketplace may thereby extend the availability of safety detection skills across organizations and may enable the adaptation of safety detection skills to diverse operational requirements.

In an embodiment, the system 107 may be further configured to support application programming interface (API) integration, security and privacy measures, and workflow integration. These features are further described in detail in reference to FIG(s). 20-22.

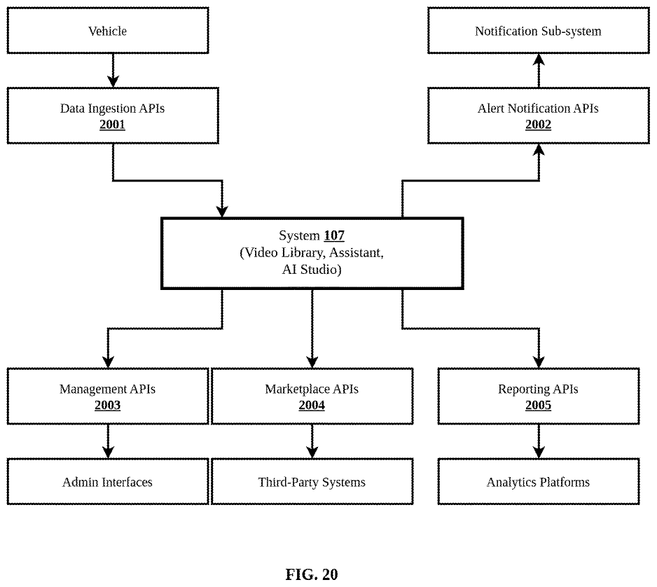

FIG. 20 illustrates example API and integration capabilities of the system 107, in accordance with an embodiment of the present disclosure.

In an embodiment, the system 107 may provide a plurality of APIs to support integration with external systems. The plurality of APIs may enable external systems to interact with the system 107 programmatically.

In an example embodiment, data ingestion APIs 2001 may enable vehicles to transmit sensor data, video data, and edge processing inference data to the system 107. The data ingestion APIs 2001 may provide the primary data pathway through which sensor data from the fleet of vehicles 201 may be received by the cloud infrastructure 202.

In an example embodiment, alert notification APIs 2002 may enable the system 107 to deliver detection results and notifications to external notification sub-systems. The alert notification APIs 2002 may support delivery of real-time alerts and notifications through the notification pathways described in the present disclosure, including email alerts, SMS notifications, and incident management system integration.

In another example embodiment, management APIs 2003 may enable external systems and admin interfaces to configure and control the system 107 programmatically. The management APIs 2003 may support operations including but not limited to deploying safety detection skills to the edge computing device 108, updating hardware profiles of edge computing devices, and modifying the one or more activation conditions of deployed safety detection skills.

In another example embodiment, marketplace APIs 2004 may enable third-party systems to access the marketplace for the purpose of discovering, deploying, and managing safety detection skills. The marketplace APIs 2004 may support programmatic access to the publication workflow and the customization workflow.

In another example embodiment, reporting APIs 2005 may enable analytics platforms and other external systems to retrieve performance data, detection statistics, and coaching records from the system 107. The reporting APIs 2005 may support both real-time and historical data retrieval.

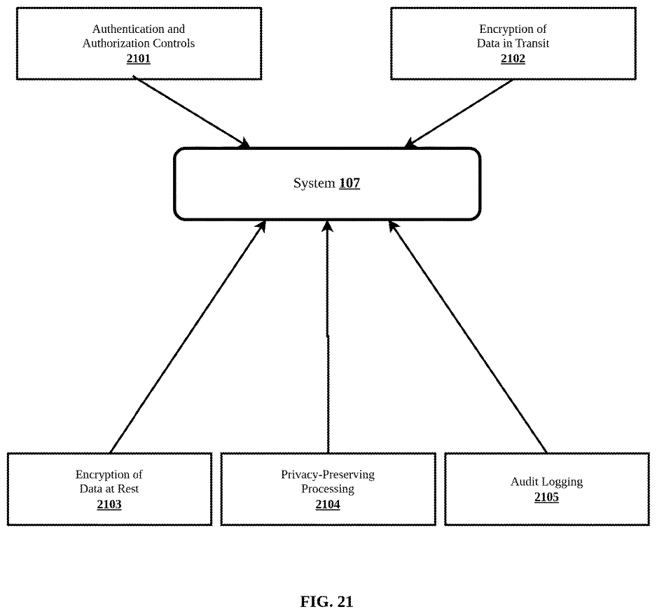

FIG. 21 illustrates example security and privacy measures implemented by the system 107, in accordance with an embodiment of the present disclosure.

In an embodiment, the system 107 may implement a plurality of security and privacy measures. The plurality of security and privacy measures may protect sensor data, detection records, and system configurations from unauthorized access and may ensure compliance with applicable regulatory requirements.

In an example embodiment, authentication and authorization controls 2101 may govern access to the functions and data of the system 107. Authentication and authorization controls 2101 may require each user accessing the system 107 through the one or more client applications 203 to authenticate using defined credentials. Authorization controls may restrict access to system functions and data based on the role and permissions of the authenticated user. Authentication and authorization controls 2101 may apply to access through the one or more client applications 203 and through the plurality of APIs.

In an example embodiment, encryption of data in transit 2102 may be applied to all data transmitted between the edge computing device 108, the cloud infrastructure 202, and the one or more client applications 203. Encryption of data in transit 2102 may employ cryptographic protocols to prevent unauthorized interception or modification of data during transmission over the communication network.

In an example embodiment, encryption of data at rest 2103 may be applied to sensor data, video segments, detection records, coaching records, and skill definitions stored in the video library 101 and other storage components of the cloud infrastructure 202. Encryption of data at rest 2103 may employ cryptographic techniques to prevent unauthorized access to stored data.

In an example embodiment, privacy-preserving processing 2104 may be applied to sensor data captured by the one or more sensors coupled to the edge computing device 108. Privacy-preserving processing 2104 may include anonymization or blurring of personally identifiable information, including facial imagery of vehicle operators, passengers, and pedestrians captured within video segments. Privacy-preserving processing 2104 may be performed on the edge computing device 108 prior to transmission of sensor data to the cloud infrastructure 202, thereby limiting the exposure of personally identifiable information in transit and at rest.

In an example embodiment, audit logging 2105 may record all access and modification events associated with the system 107. Audit logging 2105 may create a tamper-evident log of user access events, system configuration changes, safety detection skill deployments, and detection record retrievals. The audit log generated by audit logging 2105 may be retained in the cloud infrastructure 202 and may be accessible to authorized administrators through the management APIs 2003.

Accordingly, the system 107 may implement security and privacy measures across all embodiments described herein. The security and privacy measures may enable the system 107 to operate in environments subject to regulatory requirements governing the handling of sensor data, personally identifiable information, and proprietary operational data.

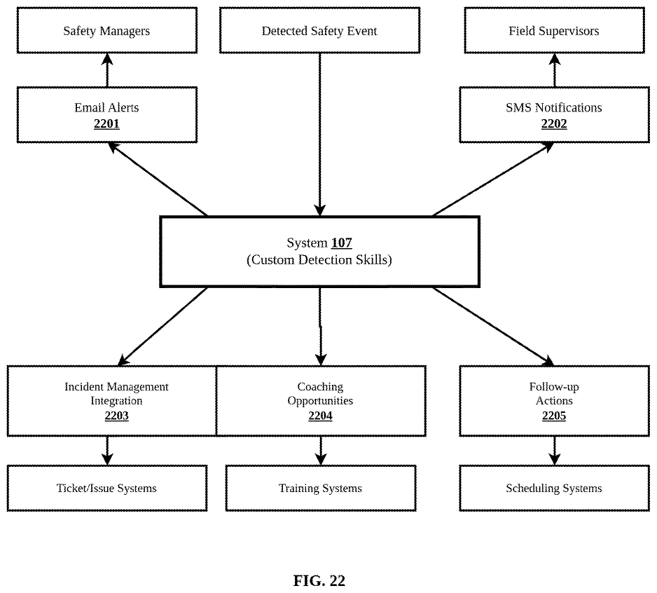

FIG. 22 illustrates example workflow integration pathways triggered upon detection of a safety event by the system 107, in accordance with an embodiment of the present disclosure.

In an embodiment, upon detection of the safety event, the system 107 may generate a real-time alert to the operator of the vehicle. The real-time alert may be generated by the edge computing device 108 locally upon completion of the unified execution pass in which the safety event is detected. The real-time alert may be presented to the operator of the vehicle through an in-vehicle display, an auditory signal, or a haptic notification. The real-time alert may include information identifying the detected safety event, the timestamp of detection, and the location of the vehicle at the time of detection. The real-time alert may be generated without requiring data transmission to the cloud computing environment 104, thereby enabling the operator of the vehicle to be notified without dependency on network connectivity.

In an embodiment, the system 107 may transmit a notification to a remote safety management application upon detection of the safety event. The notification may be transmitted from the edge computing device 108 to the computing device 106 over the communication network. The computing device 106 may forward the notification to the remote safety management application through one or more notification pathways. The notification pathways may include email alerts 2201 directed to safety managers and other designated recipients. The notification pathways may additionally include SMS notifications 2202 directed to field supervisors or other personnel requiring immediate awareness of the detected safety event. The notification pathways may further include integration with incident management sub-systems 2203. Integration with incident management sub-systems 2203 may involve the automatic creation of a ticket or issue record in a third-party incident management platform associated with the detected safety event. The ticket or issue record may include the timestamp of detection, the location of the vehicle, and a reference to the associated data segment recorded at the time of detection.

In an embodiment, the system 107 may record the detection of the safety event and an associated data segment for subsequent review. The associated data segment may include a video clip captured by the one or more sensors coupled to the edge computing device 108 at the time of detection. The associated data segment may further include sensor readings, location data, vehicle state data, and the detection output generated by the on-device large language model 501 during the unified execution pass in which the safety event was detected. The associated data segment may be stored in the video library 101 and may be associated with metadata including the timestamp of detection, the type of safety event detected, the identity of the desired safety detection skill that generated the detection, and the vehicle from which the associated data segment was captured. The stored associated data segment may be accessible to safety managers through the one or more client applications 203 for subsequent review and analysis.

In an embodiment, the system 107 may create a coaching record associated with the detection of the safety event. The coaching record may be a structured record associated with the detected safety event and the operator of the vehicle at the time of detection. The coaching record may include the associated data segment, the timestamp and location of detection, and the type of safety event detected. The coaching record may be made available to safety managers through the one or more client applications 203 to support the initiation of corrective action. Follow-up actions 2205 may be scheduled based on the coaching record. Follow-up actions 2205 may include scheduling a review meeting with the vehicle operator, initiating a training session through a training system, or scheduling a site inspection. Coaching opportunities 2204 may be automatically identified by the system 107 based on patterns observed across multiple coaching records associated with the same vehicle operator or the same type of safety event.

One or more working examples of the system 107 are further described in reference to FIG(s). 23-24.

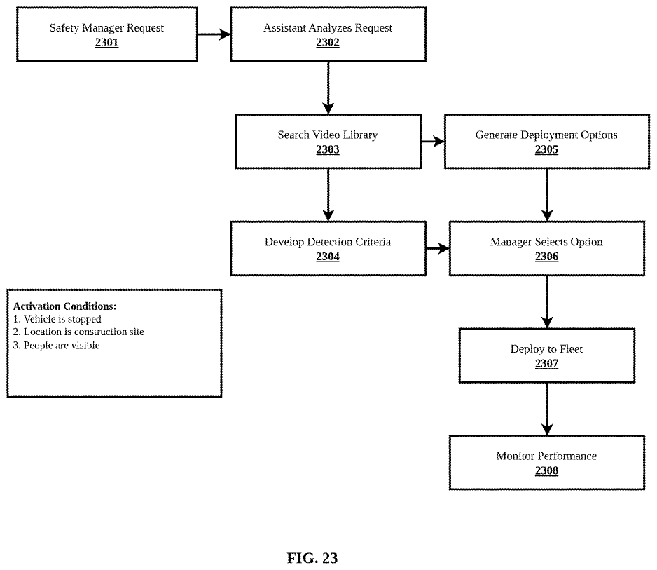

FIG. 23 illustrates an example end-to-end workflow for a construction site safety helmet detection safety detection skill, in accordance with an embodiment of the present disclosure.

In an embodiment, a safety manager associated with a construction company may submit a natural language request to the system 107 at step 2301. The natural language request may describe a desired safety detection skill for detecting workers at construction sites who are not wearing safety helmets when vehicles are present. At step 2302, the system 107 may analyze the natural language request to identify the one or more target objects, the context, and the detection goal. At step 2303, the system 107 may search the video library 101 to retrieve a plurality of video segments depicting construction sites where vehicles have been present, including video segments showing workers both with and without safety helmets under varying conditions. At step 2304, the system 107 may develop detection criteria based on the retrieved video segments. The detection criteria may specify activation conditions including that the vehicle is stopped, that the location matches known construction site coordinates or exhibits visual characteristics of a construction site, and that people are visible in the camera view. At step 2305, the system 107 may generate a plurality of deployment options for the desired safety detection skill. At step 2306, the safety manager may select one deployment option among the plurality of deployment options. At step 2307, the system 107 may deploy the desired safety detection skill to the fleet of vehicles 201 based on the selected deployment option. At step 2308, the safety manager may monitor the performance of the desired safety detection skill through a dashboard displaying detection statistics, compliance trends, and example detections.

Accordingly, the system 107 may enable the safety manager to define and deploy the construction site safety helmet detection safety detection skill through a natural language request without requiring technical expertise, and may provide ongoing performance monitoring to support refinement of the desired safety detection skill.

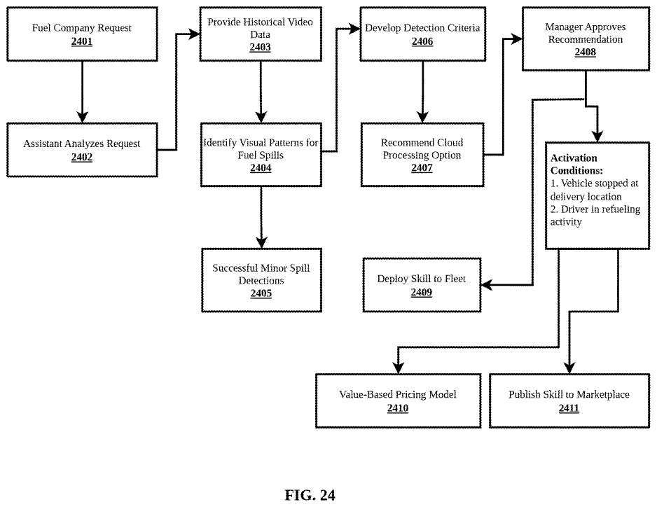

FIG. 24 illustrates an example end-to-end workflow for a fuel spill detection safety detection skill, in accordance with an embodiment of the present disclosure.

In an embodiment, a safety manager associated with a fuel delivery company may submit a natural language request to the system 107 at step 2401. The natural language request may describe a desired safety detection skill for detecting fuel spills during delivery operations. At step 2402, the system 107 may analyze the natural language request to identify the one or more target objects, the context, and the detection goal. At step 2403, the safety manager may provide access to historical video data from fuel deliveries, including incidents where spills occurred. At step 2404, the system 107 may identify visual patterns associated with fuel spills based on the historical video data. The visual patterns may include liquid pooling, spray patterns, or unusual operator movements. At step 2405, the desired safety detection skill may successfully identify minor spills that may be addressed before becoming major incidents. At step 2406, the system 107 may develop detection criteria specifying activation conditions including that the vehicle is stopped at a fuel delivery location and that the driver is engaged in refueling activity. At step 2407, the system 107 may recommend a cloud processing option based on the critical nature of fuel spill detection and the potential environmental and safety impacts. At step 2408, the safety manager may approve the recommendation. At step 2409, the system 107 may deploy the desired safety detection skill to the fleet of vehicles 201. At step 2410, the safety manager may configure a value-based pricing model reflecting potential cost savings from preventing major spill incidents. At step 2411, the safety manager may publish the desired safety detection skill to the marketplace, making the desired safety detection skill available to other fuel delivery companies.

Accordingly, the system 107 may enable the safety manager to define and deploy the fuel spill detection safety detection skill through a natural language request, and may further enable the safety manager to publish the desired safety detection skill to the marketplace for adoption by other organizations operating in the fuel delivery industry.

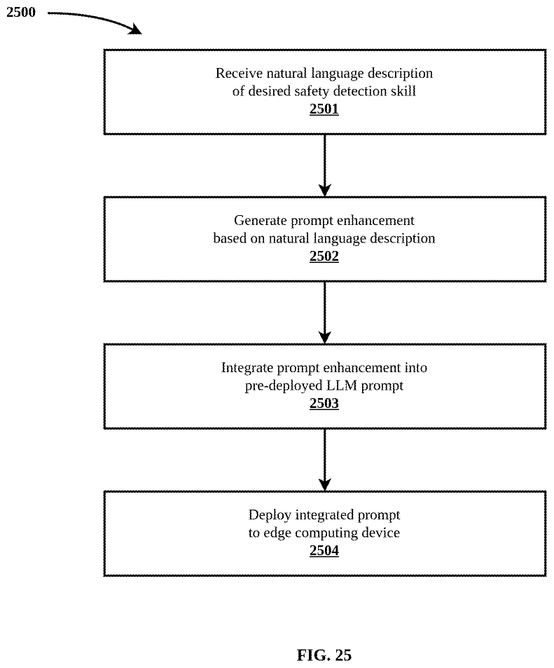

FIG. 25 illustrates a flow chart depicting a method 2500 for deploying a custom detection skill to an edge computing device of a vehicle, according to an embodiment of the present disclosure.

The method 2500 may be a computer-implemented method executed by the computing device 106 and the system 107, including the video library 101, the driver assistant 102, and the AI studio 103. For the sake of brevity, constructional and operational features of the system 107 that are already explained in the description of FIG. 1 through FIG. 24 are not explained in detail in the description of FIG. 25.

The method 2500, at step 2501, involves receiving, by the computing device 106, a natural language description of a desired safety detection skill. In the step 2501, the natural language description indicates a type of a safety event. In the step 2501, the natural language description further indicates one or more conditions for detection of the safety event.

Thereafter, at step 2502, the method 2500 involves generating, by the computing device 106, a prompt enhancement based on the natural language description. In the step 2502, the prompt enhancement comprises machine-interpretable instructions. In the step 2502, the machine-interpretable instructions are configured to cause the LLM to detect the safety event when the one or more conditions are satisfied.

Subsequently, at step 2503, the method 2500 involves integrating, by the computing device 106, the prompt enhancement into a pre-deployed LLM prompt executing on at least one edge computing device associated with a vehicle to produce an integrated prompt. In the step 2503, the integrated prompt is configured to detect one or more pre-existing safety events associated with the pre-deployed LLM prompt. In the step 2503, the integrated prompt is further configured to detect the safety event in a unified execution pass of the LLM.

Following this, at step 2504, the method 2500 involves deploying, by the computing device 106, the integrated prompt to the at least one edge computing device. In the step 2504, the integrated prompt is deployed for processing sensor data captured by one or more sensors coupled to the at least one edge computing device. In the step 2504, the processing of the sensor data is performed to detect the safety event.

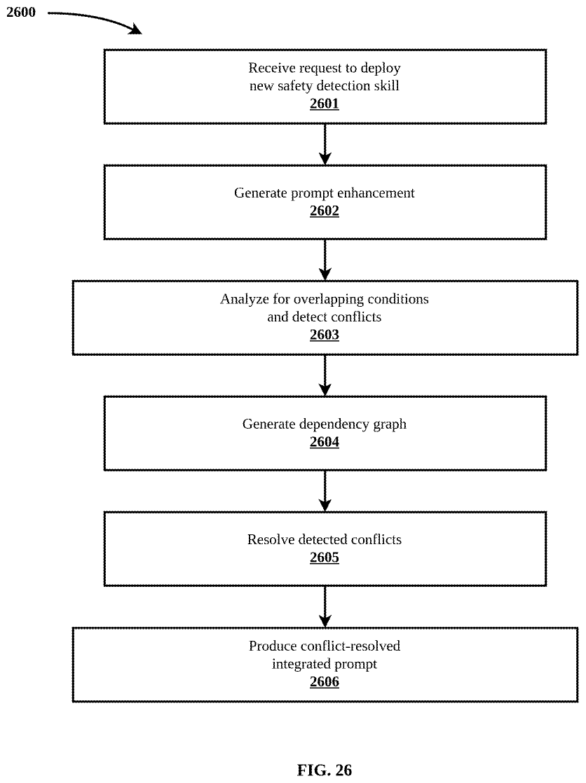

FIG. 26 illustrates a flow chart depicting a method 2600 for managing a plurality of safety detection skills on the edge computing device of the vehicle, according to an embodiment of the present disclosure.

The method 2600 may be a computer-implemented method executed by the computing device 106 and the system 107, including the video library 101, the driver assistant 102, and the AI studio 103. For the sake of brevity, constructional and operational features of the system 107 that are already explained in the description of FIG. 1 through FIG. 25 are not explained in detail in the description of FIG. 26.

The method 2600, at step 2601, involves receiving, by the computing device 106, a request to deploy a new safety detection skill to the edge computing device. In the step 2601, the edge computing device executes the on-device LLM. In the step 2601, the on-device large language model operates according to a structured prompt. In the step 2601, the structured prompt comprises the one or more pre-existing safety detection skills.

Thereafter, at step 2602, the method 2600 involves generating, by the computing device 106, a prompt enhancement corresponding to the new safety detection skill.

Subsequently, at step 2603, the method 2600 involves analyzing, by the computing device 106, the prompt enhancement in combination with prompt components corresponding to the one or more pre-existing safety detection skills. In the step 2603, the analyzing identifies one or more overlapping conditions or shared sub-operations. In the step 2603, the analyzing further detects one or more conflicts in at least one of resource utilization or detection logic.

Following this, at step 2604, the method 2600 involves generating, by the computing device 106, a dependency graph representing relationships among the new safety detection skill and the one or more pre-existing safety detection skills.

Thereafter, at step 2605, the method 2600 involves resolving, by the computing device 106, each detected conflict among the one or more conflicts. In the step 2605, resolving each detected conflict involves performing at least one of: applying a prioritization rule designating a precedence order among conflicting skills, imposing a conditional activation constraint preventing concurrent evaluation of conflicting skills, or consolidating shared sub-operations to eliminate redundant processing. In the step 2605, the applying of the prioritization rule designates a precedence order among conflicting skills. In the step 2605, the imposing of the conditional activation constraint prevents concurrent evaluation of conflicting skills. In the step 2605, the consolidating of shared sub-operations eliminates redundant processing.

Subsequently, at step 2606, the method 2600 involves producing, by the computing device 106, a conflict-resolved integrated prompt. In the step 2606, the conflict-resolved integrated prompt incorporates the new safety detection skill and the one or more pre-existing safety detection skills. In the step 2606, the conflict-resolved integrated prompt is deployable to the edge computing device for execution by the on-device large language model.

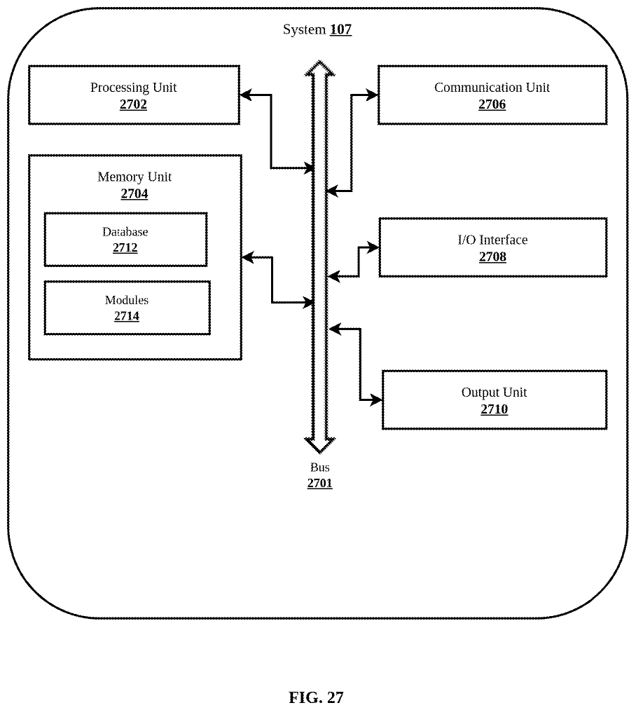

FIG. 27 illustrates a block diagram of a system 107, in accordance with an embodiment of the present disclosure.

As shown in FIG. 27, the system 107 may include a bus 2701, a processing unit 2702, a memory unit 2704, a communication unit 2706, an I/O interface 2708, and an output unit 2710. In another embodiment, the system 107 implemented at least in the edge computing device 108 acts as a virtual machine running on host hardware.

The processing unit 2702 may include one or more processors as a single processing unit or several units. The processing unit 2702 may be implemented as one or more microprocessors, microcomputers, microcontrollers, digital signal processors, central processing units, state machines, logic circuitries, and/or any devices that manipulate signals based on operational instructions. Among other capabilities, the one or more processors are configured to fetch and execute computer-readable instructions and data stored in the memory unit 2704.

The memory unit 2704 includes one or more computer-readable storage media that can communicate via the bus 2701. The memory unit 2704 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that can, over time, change (e.g., in Random Access Memory (RAM) or cache).

The memory unit 2704 may further include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory unit 2704 includes a database 2712 and modules 2714. The database 2712 may be configured to be accessed by the processing unit 2702 and may store information as required by the processing unit 2702 to perform the one or more functions described in the present disclosure. The database 2712 may store skill definitions, prompt enhancements, structured prompts, hardware profiles associated with edge computing devices, deployment option configurations, detection records, and associated metadata. The database 2712 may additionally store video segments, user feedback records, and marketplace-related data including published safety detection skills, usage terms, and revenue sharing configurations.

The modules 2714 may include routines, programs, objects, components, data structures, and other elements that perform particular tasks or implement data types as described in the present disclosure. The modules 2714 may also be implemented as signal processors, state machines, logic circuitries, or any other device or component that manipulates signals based on operational instructions.

The modules 2714 may be implemented in hardware, instructions executed by the processing unit 2702, or by a combination thereof. The processing unit 2702 may comprise a computer, a processor, a state machine, a logic array, or any other suitable device capable of processing instructions. The processing unit 2702 may be a general-purpose processor that executes instructions to cause the general-purpose processor to perform the functions described in the present disclosure, or the processing unit 2702 may be dedicated to performing the required functions. In another embodiment of the present disclosure, the modules 2714 may be machine-readable instructions which, when executed by the processing unit 2702, perform the methods described in the present disclosure.

The modules 2714 may implement the one or more large language models and AI capabilities described in the present disclosure, including the natural language processing capabilities utilized by the driver assistant 102, the computer vision capabilities utilized by the AI studio 103, and the prompt enhancement generation, conflict resolution, and deployment option generation functions performed by the system 107. The modules 2714 may further implement the video library 101 indexing and retrieval functions, the interactive alert builder interface, and the marketplace publication and customization functions described herein.

The communication unit 2706 is configured to communicate sensor data, or any other content over a communication network via a communication port or interface or using the bus 2701. Further, the communication unit 2706 may include a communication port or a communication interface for sending and receiving simulation datasets via the communication network. The communication port or the communication interface may be a part of the processing unit 2702 or may be a separate component. The communication port may be created in software or may be a physical connection in hardware. The communication port may be configured to connect with the communication network, external media, the display, or any other components in the system 107, or combinations thereof. The connection with the communication network may be a physical connection, such as a wired Ethernet connection, or may be established wirelessly as discussed above. Likewise, the additional connections with other components of the system 107 may be physical or may be established wirelessly. The communication unit 2706 may include the Wi-Fi module or Bluetooth module for enabling wireless communication capability and data exchange capability between various modules of the system 107.

The I/O interface 2708 refers to hardware or software components that enable communication between various modules of the system 107. The I/O interface 2708 serves as a communication medium for exchanging information, commands, signals, or query responses with other devices or systems. The I/O interface 2708 may be a part of the processing unit 2702 or maybe a separate component. The I/O interface 2708 may be created in software or maybe a physical connection in hardware. The I/O interface 2708 may be configured to connect with an external network, external media, the display, or any other components, or combinations thereof. The external network may be a physical connection, such as a wired Ethernet connection, or may be established wirelessly.

The output device 2710 which is preferably an output unit comprises of a display device. The display device may be an Augmented Reality/Virtual Reality (AR/VR) device to display a virtual environment to the user. The display device may include a display screen. As a non-limiting example, the display screen may be Light Emitting Diode (LED), Liquid Crystal Display (LCD), Organic Light Emitting Diode (OLED), Active Matrix Organic Light Emitting Diode (AMOLED), or Super Active Matrix Organic Light Emitting Diode (AMOLED) screen. The display screen may be of varied resolutions. The remote device, while operating as the output unit, is further configured for presenting the selected frames disclosed in the present disclosure.

At least by virtue of the aforesaid, the present subject matter at least provides the following advantages:

The systems and methods of the present disclosure herein enables a safety manager or other authorized user to define and deploy a custom safety detection skill through a natural language description without requiring technical expertise in machine learning, computer vision, or software engineering, thereby eliminating the dependency on technical development teams and significantly reducing the time required to deploy new safety detection capabilities.

The systems and methods of the present disclosure herein generates a prompt enhancement and integrates the prompt enhancement into a pre-deployed LLM prompt executing on the edge computing device, thereby enabling detection of a plurality of safety events in a unified execution pass of the on-device LLM without requiring separate inference passes for each safety detection skill.

The systems and methods of the present disclosure enable unified execution pass detection, thereby eliminating multiplicative increases in memory utilization, processing overhead, and power consumption.

The systems and methods of the present disclosure insert prompt enhancements into designated custom detection task sections, thereby preserving pre-existing safety detection skills in an unmodified state during integration.

The systems and methods of the present disclosure generate conditional activation logic, thereby ensuring computational resources are consumed only when activation conditions are satisfied.

The systems and methods of the present disclosure refine prompt enhancements based on determined resource constraints, thereby preserving detection accuracy while accommodating edge computing device limitations.

The systems and methods of the present disclosure translate natural language descriptions into machine-executable logic representations serialized in structured portable data formats, thereby providing hardware-agnostic representations deployable across heterogeneous edge computing devices.

The systems and methods of the present disclosure generate dependency graphs representing relationships among safety detection skills, thereby enabling systematic identification and resolution of conflicts prior to deployment.

The systems and methods of the present disclosure resolve conflicts through prioritization rules, conditional activation constraints, or consolidation of shared sub-operations, thereby producing conflict-resolved integrated prompts in resource-optimized form.

The systems and methods of the present disclosure consolidate detection operations for common object types into single shared detection operations, thereby eliminating redundant object detection operations and reducing inference overhead.

The systems and methods of the present disclosure generate and present a plurality of deployment options, thereby enabling informed deployment decisions based on operational requirements and budget constraints.

The systems and methods of the present disclosure support piggybacking deployment options, thereby avoiding independent activation polling mechanisms and reducing computational overhead.

The systems and methods of the present disclosure adapt integrated prompts based on hardware profiles, thereby enabling fleet-wide deployment across edge computing devices having differing resource constraints.

The systems and methods of the present disclosure monitor performance metrics and refine prompt enhancements upon identification of performance degradation, thereby providing a closed-loop remediation mechanism.

The systems and methods of the present disclosure enable marketplace publication and derivative skill creation, thereby facilitating knowledge sharing and accelerating adoption across organizations.

The systems and methods of the present disclosure dispatch natural language descriptions to an agentic artificial intelligence engine for automated detection criteria generation, thereby enabling high-quality safety detection skills without requiring manual annotation or programming expertise.

The systems and methods of the present disclosure implement authentication, encryption, privacy-preserving processing, and audit logging, thereby enabling operation in environments subject to regulatory requirements.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practised with modification within the scope of the embodiments as described herein.

What is claimed is:

1. A method comprising:
receiving, by a computing device, a natural language description of a desired safety detection skill, the natural language description indicating a type of a safety event and one or more conditions for detection of the safety event;
generating, by the computing device, a prompt enhancement based on the natural language description, the prompt enhancement comprising machine-interpretable instructions configured to cause a large language model (LLM) to detect the safety event when the one or more conditions are satisfied;
integrating, by the computing device, the prompt enhancement into a pre-deployed LLM prompt executing on at least one edge computing device associated with a vehicle to produce an integrated prompt, the integrated prompt being configured to detect one or more pre-existing safety events associated with the pre-deployed LLM prompt and the safety event in a unified execution pass of the LLM; and
deploying, by the computing device, the integrated prompt to the at least one edge computing device for processing sensor data captured by one or more sensors coupled to the at least one edge computing device to detect the safety event.

2. The method of claim 1, wherein receiving the natural language description comprises:
presenting, by the computing device, an interactive alert builder interface to a user;
receiving, by the computing device via the interactive alert builder interface, a user selection of one or more target objects; and
receiving, by the computing device via the interactive alert builder interface, a specification of at least one spatial relationship between two or more of the one or more target objects, the at least one spatial relationship defining a triggering condition for the safety event.

3. The method of claim 2, wherein the at least one spatial relationship comprises at least one of:
an overlap condition specifying that a spatial overlap ratio between bounding regions of a first target object and a second target object exceeds an overlap threshold;
a proximity condition specifying that a distance metric between the first target object and the second target object falls below a distance threshold; or
a movement condition specifying that a change in relative position between the first target object and the second target object across successive frames satisfies a directional criterion.

4. The method of claim 1, further comprising:
translating, by the computing device, the natural language description into a machine-executable logic representation comprising one or more Boolean operators combining a plurality of detection conditions, each detection condition corresponding to at least one of a detected object state, a sensor reading threshold, or a spatial relationship between detected objects; and
serializing the machine-executable logic representation and one or more associated object embeddings into a structured portable data format for transmission to the at least one edge computing device.

5. The method of claim 1, wherein the pre-deployed LLM prompt comprises a base detection task section defining the one or more pre-existing safety events and a custom detection task section, and wherein integrating the prompt enhancement comprises inserting the prompt enhancement into the custom detection task section.

6. The method of claim 1, wherein integrating the prompt enhancement into the pre-deployed LLM prompt comprises:
determining one or more resource constraints of the at least one edge computing device, the one or more resource constraints comprising at least one of a memory constraint, a processing constraint, or a power consumption constraint;
refining the prompt enhancement to operate within the determined one or more resource constraints while preserving detection accuracy for the safety event; and
integrating the refined prompt enhancement into the pre-deployed LLM prompt.

7. The method of claim 1, wherein generating the prompt enhancement further comprises: generating conditional activation logic indicating one or more activation conditions under which the desired safety detection skill is to be evaluated, the prompt enhancement being structured such that the LLM bypasses evaluation of the desired safety detection skill when the one or more activation conditions are not satisfied.

8. The method of claim 7, wherein the one or more activation conditions comprise at least one of a vehicle state condition, a geographic condition, a temporal condition, an environmental condition, or a prior detection condition.

9. The method of claim 1, wherein prior to deploying the integrated prompt, the method further comprises:
generating, by the computing device, a plurality of deployment options for the desired safety detection skill, each deployment option specifying at least a deployment architecture, a resource requirement estimate, an expected performance metric, and a cost estimate;
presenting the plurality of deployment options to a user via a user interface; and
receiving a selection of one of the plurality of deployment options from the user,
wherein deploying the integrated prompt is performed based on the selected deployment option.

10. The method of claim 9, wherein the plurality of deployment options comprises at least two of a cloud-based deployment option, an edge device deployment option, a hybrid deployment option, or a piggybacking deployment option, and wherein generating the piggybacking deployment option comprises:
identifying one or more pre-existing detection events associated with the pre-deployed LLM prompt that share at least one common triggering condition with the desired safety detection skill; and
configuring the piggybacking deployment option to activate the desired safety detection skill upon occurrence of the one or more pre-existing detection events.

11. The method of claim 1, wherein prior to generating the prompt enhancement, the method comprises:
dispatching, by the computing device, the natural language description to an agentic artificial intelligence engine, wherein the agentic artificial intelligence engine is configured to:
search a video database to retrieve a plurality of video segments relevant to the safety event;
analyze the plurality of video segments to identify one or more visual patterns distinguishing a compliant state from a non-compliant state across varying conditions; and
generate one or more detection criteria based on the identified one or more visual patterns.

12. The method of claim 11, further comprising:
presenting the one or more detection criteria and one or more sample detections to a user via a user interface; and
receiving feedback from the user, the agentic artificial intelligence engine being configured to refine the one or more detection criteria based on the received feedback.

13. The method of claim 1, wherein deploying the integrated prompt comprises deploying the integrated prompt to a plurality of edge computing devices associated with a fleet of vehicles, the method further comprising:
determining a hardware profile for each edge computing device; and
adapting the integrated prompt based on the hardware profile of each respective edge computing device to accommodate differing resource constraints across the fleet.

14. The method of claim 1, further comprising:
publishing the desired safety detection skill to a marketplace accessible to a plurality of users; and
enabling a second user to at least one of deploy the desired safety detection skill to a second fleet of vehicles, or create a derivative version of the desired safety detection skill by modifying at least one of: one or more detection parameters, one or more activation conditions, or one or more detection thresholds.

15. The method of claim 1, wherein in response to a detection of the safety event, the method comprises:
performing at least one of: generating a real-time alert to an operator of the vehicle, transmitting a notification to a remote safety management application, recording the detection and an associated data segment for subsequent review, or creating a coaching record associated with the detection.

16. A system comprising:
one or more processors; and
a memory storing instructions that, when executed by the one or more processors, cause the system to:
receive a natural language description of a desired safety detection skill, the natural language description indicating a type of a safety event and one or more conditions for detection of the safety event;
generate a prompt enhancement based on the natural language description, the prompt enhancement comprising machine-interpretable instructions configured to cause a large language model (LLM) to detect the safety event when the one or more conditions are satisfied;
integrate the prompt enhancement into a pre-deployed LLM prompt executing on at least one edge computing device associated with at least one vehicle to produce an integrated prompt, the integrated prompt being configured to detect one or more pre-existing safety events associated with the pre-deployed LLM prompt and the safety event in a unified execution pass of the LLM; and
deploy the integrated prompt to the at least one edge computing device for processing sensor data captured by one or more sensors coupled to at least one edge computing device to detect the safety event.

17. A method for managing a plurality of safety detection skills on an edge computing device of a vehicle, the method comprising:
receiving, by a computing device, a request to deploy a new safety detection skill to the edge computing device, the edge computing device executing an on-device large language model operating according to a structured prompt comprising one or more pre-existing safety detection skills;
generating, by the computing device, a prompt enhancement corresponding to the new safety detection skill;
analyzing, by the computing device, the prompt enhancement in combination with prompt components corresponding to the one or more pre-existing safety detection skills to identify one or more overlapping conditions or shared sub-operations, and to detect one or more conflicts in at least one of resource utilization or detection logic;
generating, by the computing device, a dependency graph representing relationships among the new safety detection skill and the one or more pre-existing safety detection skills;
resolving, by the computing device, each detected conflict by performing at least one of:
applying a prioritization rule designating a precedence order among conflicting skills,
imposing a conditional activation constraint preventing concurrent evaluation of conflicting skills, or
consolidating shared sub-operations to eliminate redundant processing; and
producing a conflict-resolved integrated prompt incorporating the new safety detection skill and the one or more pre-existing safety detection skills, the conflict-resolved integrated prompt being deployable to the edge computing device for execution by the on-device large language model.

18. The method of claim 17, further comprising:
monitoring one or more performance metrics of the conflict-resolved integrated prompt on the edge computing device after deployment;
identifying at least one performance degradation attributable to the new safety detection skill; and
refining at least one of the prompt enhancement or the prioritization rule to remediate the at least one performance degradation.

19. The method of claim 17, wherein consolidating shared sub-operations comprises:
identifying that the new safety detection skill and at least one of the one or more pre-existing safety detection skills require detection of a common object type under different respective conditions; and
consolidating a detection operation for the common object type into a single shared detection operation, the conflict-resolved integrated prompt being configured to apply the different respective conditions of each skill to a result of the single shared detection operation.

20. The method of claim 17, further comprising:
deploying the conflict-resolved integrated prompt to a plurality of edge computing devices associated with a fleet of vehicles; and
adapting the conflict-resolved integrated prompt for each edge computing device based on a respective hardware profile to accommodate differing resource constraints across the fleet.
